(19) United States
(12) Patent Application Publication
(10) Pub. No.: US 2005/0195223 A1
(43) Pub. Date: Sep. 8, 2005

(54) Light modulating apparatus, optical display apparatus, light modulation control program, optical display apparatus control program, light modulation control method, and optical display apparatus control method

(75) Inventors: Takashi Nitta, Chino-shi (JP); Junichi Nakamura, Shiojiri-shi (JP); Shoichi Uchiyama, Suwa-gun (JP); Tsunemori Asahi, Hotaka-machi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/068,899

(22) Filed: Mar. 2, 2005

(30) Foreign Application Priority Data
Mar. 5, 2004 (JP) 2004-062294

(51) Int. Cl. G09G 3/36

(52) U.S. Cl. 345/690

(57) ABSTRACT

Exemplary embodiments of the invention to provide a light modulating apparatus suitable to expand the brightness dynamic range and number of levels of gray of display images to enhance image quality by modulating light from a light source in two stages via a first light modulator device and a second light modulator device, and displaying images according to the resolution of the second light modulator device higher than the resolution of the first light modulator device.

### BACKGROUND

Exemplary embodiments of the present invention relate to an apparatus for displaying images by modulating light from a light source via plural light modulator devices. Exemplary embodiments provide a light modulating apparatus, an optical display apparatus, a light modulation control program, an optical display apparatus control program, a light modulation control method, and an optical display apparatus control method suitable for realizing expansion of the brightness dynamic range and the number of levels of gray.

In the related art, image quality improvement in optical display apparatuses such as an LCD (Liquid Crystal Display), an EL, a plasma display, a CRT (Cathode Ray Tube), and a projector is remarkable and performance comparable to the human visual properties is being realized with respect to resolution and color gamut. However, with respect to the brightness dynamic range, its reproduced range remains at highest on the order of 1 to 10² [nit], and further, the number of levels of gray is generally 8 bits. On the other hand, the human visual perception provides a brightness dynamic range that can be perceived at a time is on the order of 10⁻² to 10⁴ [nit]. Further, the brightness discriminative ability is on the order of 0.2 [nit], and this is said to be equal to 12 bits in terms of number of levels of gray. Seeing a display image of a current optical display apparatus through such visual properties, the human does not satisfy the reality and impact because the narrowness of the brightness dynamic range stands out and additionally, the levels of gray in shadow parts and highlight parts are insufficient.

Further, in computer graphics (hereinafter, abbreviated to “CG”) used for movies or games, the movement for pursuing description reality by providing display data (hereinafter, referred to as “HDR (High Dynamic Range) display data”) with brightness dynamic range and number of levels of gray close to human visual perception is becoming the mainstream. However, there is a problem that powers of expression the CG contents originally have can not be exerted sufficiently because the performance of the optical display apparatus for displaying CG is insufficient.

Furthermore, in the next OS (Operative System), 16-bit color space is planned to be adopted, and the brightness dynamic range and the number of levels of gray will be increased dramatically compared to those in the current 8-bit color space. Accordingly, realization of an optical display apparatus capable of utilizing the 16-bit color space is desired.

Among optical display apparatuses, projection display apparatuses such as a liquid crystal projector and DLP (Digital Light Processing, a trademark of TI Inc.) projector can perform big-screen display and are effective apparatuses for reproducing the reality and impact of display images. In this field, the following proposals are made in order to address or solve the above described and/or other problems.

In the related art, projection display apparatus with high dynamic range, for example, are technologies disclosed in Publication of Japanese Patent Application No. 2001-100689, Publication of Japanese Patent Application No. 2002-99250 and Helge Seetzen, Lorne A. Whitehead, Greg Ward, “A High Dynamic Range Display Using Low and High Resolution Modulators”, SID Symposium 2003, pp. 1450-1453 (2003). In the technologies, a light source, a first light modulator device for modulating brightness of all wavelength ranges of light, and a second light modulator device for modulating the brightness of the wavelength ranges are provided with respect to respective wavelength ranges of RGB three primary colors of the wavelength ranges of light for forming a desired brightness distribution by modulating light from the light source by the first light modulator device, imaging the optical image thereof onto a display surface of the second light modulator device and performing color modulation, and projecting the secondary modulated light. The respective pixels of the first light modulator device and the second light modulator device are separately controlled based on the first control value and the second control value determined from the HDR display data, respectively. As the light modulator device, a transmittance modulator device having a pixel structure or segment structure with independently controllable transmittances and capable of controlling a two-dimensional transmittance distribution is used. As a representative example thereof, a liquid crystal light valve can be cited. Further, a reflectance modulator device may be used in place of transmittance modulator device, and as a representative example thereof, a DMD (Digital Micromirror Device) can be cited.

Now, the case of using a light modulator device having a transmittance of dark display of 0.2% and a transmittance of light display of 60% is considered. Regarding the light modulator device alone, the brightness dynamic range is 60/0.2=300. The related art projection display apparatus corresponds to the case where light modulator devices having the brightness dynamic range of 300 are optically and serially arranged, and thereby, the brightness dynamic range of 300×300=90000 can be realized. Further, the equal way of thinking is held with respect to the number of levels of gray, and the number of levels of gray exceeding 8 bits can be obtained by optically and serially arranging light modulator devices with 8-bit levels of gray.

In addition, as a projection display apparatus that realizes a high brightness dynamic range, for example, the related art includes a projection display apparatus disclosed in Helge Seetzen, Lorne A. Whitehead, Greg Ward, “A High Dynamic Range Display Using Low and High Resolution Modulators”, SID Symposium 2003, pp. 1450-1453 (2003) and a display apparatus disclosed in Publication of Japanese Patent Application No. 2002-99250.

Both of the inventions disclosed in Helge Seetzen, Lorne A. Whitehead, Greg Ward, “A High Dynamic Range Display Using Low and High Resolution Modulators”, SID Symposium 2003, pp. 1450-1453 (2003) and Publication of Japanese Patent Application No. 2002-99250 use LCDs as first light modulator devices and LEDs or modulatable lights such as fluorescent lamps as second light modulator devices.

### SUMMARY

However, the HDR display data is image data capable of realizing higher brightness dynamic range that can not be realized in a related art image format such as sRGB, and stores pixel values representing brightness levels of pixels with respect to all pixels. Given that the brightness level of pixel p in the HDR display data is Rp, the transmittance of a pixel corresponding to pixel p of the first light modulator device is T1, and the transmittance of a pixel corresponding to pixel p of the second light modulator device is T2, the following equations (1) and (2) are held.
Rp=Tp×Rs (1)
Tp=T1×T2G (2)

Note that in the equations (1) and (2), Rs is brightness of the light source and G is gain, and both of them are constants. Further, Tp is a light modulation rate.

From the above equations (1) and (2), it is known that there are thousands of combinations of T1 and T2 with respect to pixel p. However, that does not mean that T1 and T2 are determined arbitrarily. The image quality is sometimes deteriorated depending on the way of determination, T1 and T2 are required to be determined appropriately in consideration of image quality.

The invention disclosed in Helge Seetzen, Lorne A. Whitehead, Greg Ward, “A High Dynamic Range Display Using Low and High Resolution Modulators”, SID Symposium 2003, pp. 1450-1453 (2003) gives only a schematic explanation about realization of high brightness dynamic range using two light modulator devices, but does not disclose how to determine the control values (i.e., T1 and T2) of each pixel of the first light modulator device and the second light modulator device based on the HDR display data, and how to control using the control values. Therefore, there is a problem that the image quality is deteriorated depending on the way of determining T1 and T2 and the way of control according to the determined control values.

On the other hand, the invention disclosed in Publication of Japanese Patent Application No. 2002-99250 describes the method for realizing the expansion of the brightness dynamic range by brightness control of the backlight and transmittance control of the LCD in detail, however, a specific method for realizing the expansion of the brightness dynamic range is not described with respect to other constitution using a different combination of backlight and LCD from the combination as described above for the first light modulator device and the second light modulator device or a constitution in which resolution of the first light modulator device and the second light modulator device is different.

Accordingly, exemplary embodiment of the invention is addressed by focusing attention on the unsolved problems the related art technologies have, and objected to provide a light modulating apparatus, an optical display apparatus, a light modulation control program, an optical display apparatus control program, a light modulation control method, and an optical display apparatus control method suitable for expanding the brightness dynamic range and the number of levels of gray of display images to enhance image quality by modulating light from a light source in two stages via a first light modulator device and a second light modulator device, and displaying images according to the resolution of the second light modulator device higher than the resolution of the first light modulator device.

### Exemplary Embodiment 1

In order to address or accomplish the above described object, a light modulating apparatus of exemplary embodiment 1 is an apparatus applied to an optical system including a first light modulator device having a plurality of pixels with independently controllable light propagation characteristics and a second light modulator device having a larger number of pixels than the first light modulator device with independently controllable light propagation characteristics for making the pixels of the first light modulator device optically correspond to the pixels of the second light modulator device at a ratio of 1: n (n is an integral number equal to or more than 2) and modulating light from a light source via the first light modulator device and the second light modulator device, the apparatus characterized by
setting a plurality of kinds of control patterns in which part of n pixels of the second light modulator device are made to have predetermined light propagation characteristics and the rest are made to have light propagation characteristics for providing the lowest or substantially the lowest light propagation efficiency, and
controlling n pixels of the second light modulator device corresponding to one pixel of the first light modulator device with one of the plurality of kinds of control patterns and switching the control pattern of the pixels of the second light modulator device according to switching timing of the light propagation characteristics of the pixel of the first light modulator device.

When such a constitution is adopted, n pixels of the second light modulator device corresponding to one pixel of the first light modulator device can be controlled with one of the plurality of kinds of control patterns. The control pattern of the pixels of the second light modulator device can be switched according to switching timing of the light propagation characteristics of the pixel of the first light modulator device.

Therefore, by switching light propagation characteristics of n pixels in the second light modulator device corresponding to each pixel of the first light modulator device to suitable light propagation characteristics with respect to each pixel according to the switching timing of each pixel of the first light modulator device, the effect that an optical image formed by light with resolution (the number of pixels) that the second light modulator device has can be transmitted to a target position is obtained.

Further, since the light of the light source is modulated in two stages by the first light modulator device and the second light modulator device, the effect that relatively high brightness dynamic range and number of levels of gray can be realized is obtained.

Here, light propagation characteristics refer to characteristics having influences on light propagation, and include propagation characteristics such as transmission characteristics, reflection characteristics, and refraction characteristics of light, for example. Hereinafter, the same is true with the optical display apparatus of exemplary embodiment 2, the light modulating apparatus of the exemplary embodiments 12 and 13, the light modulation control program of the exemplary embodiments 14, 24, and 25, the optical display apparatus control program of the exemplary embodiment 15, and the light modulation control method of the exemplary embodiments 26, 37, and 38, and the optical display apparatus control method of the exemplary embodiment 27.

Further, the light modulator device includes devices such as liquid crystal light valves and DMDs that can control light propagation characteristics such as transmittances and reflectances with respect to each pixel as described above. Hereinafter, the same is true with the optical display apparatus of exemplary embodiment 2, the light modulating apparatus of exemplary embodiments 12 and 13, the light modulation control program of the exemplary embodiments 14, 24, and 25, the optical display apparatus control program of the exemplary embodiment 15, and the light modulation control method of the exemplary embodiments 26, 37, and 38, and the optical display apparatus control method of exemplary embodiment 27.

Further, the plurality of kinds of control patterns for n pixels of the second light modulator device include a combination in which all of n pixels of the second light modulator device are made to have light propagation characteristics for providing the lowest or substantially the lowest light propagation efficiency. Hereinafter, the same is true with the optical display apparatus of exemplary embodiment 2, the light modulation control program of exemplary embodiment 12, the optical display apparatus control program of exemplary embodiment 13, and the light modulation control method of exemplary embodiment 26, and the optical display apparatus control method of exemplary embodiment 27.

### Exemplary Embodiment 2

On the other hand, in order to address or accomplish the above described object, an optical display apparatus of exemplary embodiment 2 is an apparatus including a first light modulator device having a plurality of pixels with independently controllable light propagation characteristics and a second light modulator device having a plurality of pixels with independently controllable light propagation characteristics for making the pixels of the first light modulator device optically correspond to the pixels of the second light modulator device at a ratio of 1: n (n is an integral number equal to or more than 2) and displaying an image by modulating light from a light source via the first light modulator device and the second light modulator device, the apparatus characterized by
segmenting a pixel value corresponding to one pixel of display image data into a pixel value for controlling the first light modulator device and a pixel value for controlling the second light modulator device, respectively, and further segmenting the pixel value for controlling the first light modulator device into a plurality of primitive pixel values,
setting a plurality of kinds of control patterns in which part of n pixels of the second light modulator device are made to have predetermined light propagation characteristics and the rest are made to have light propagation characteristics for providing the lowest or substantially the lowest light propagation efficiency based on the pixel value for controlling the second light modulator device, and
a first light propagation characteristic control device for switch controlling the light propagation characteristics of the pixel of the first light modulator device in a time-sharing manner based on the respective primitive pixel values for controlling the first light modulator device; and
a second light propagation characteristic control device for switch controlling the control pattern of the pixels of the second light modulator device according to switching timing of the light propagation characteristics of the pixel of the first light modulator device.

When such a constitution is adopted, the light propagation characteristics of the pixel of the first light modulator device can be switch controlled in a time-sharing manner based on the respective primitive pixel values for controlling the first light modulator device by the first light propagation characteristic control device, and the control pattern of the pixels of the second light modulator device can be switch controlled according to switching timing of the light propagation characteristics of the pixel of the first light modulator device by the second light propagation characteristic control device.

Therefore, by switching the control patterns of the light propagation characteristics of n pixels of the second light modulator device at high speed in a time-sharing manner according to the switching timing of each pixel of the first light modulator device based on the display image data, the effect that an image of the display image data with resolution the second light modulator device has can be displayed, is obtained.

Further, since the light of the light source is modulated in two stages by the first light modulator device and the second light modulator device, the effect that relatively high brightness dynamic range and number of levels of gray can be realized, is obtained.

Here, the primitive pixel values are values representing color information of an image, and, for example, in the case where pixel values of the display image data include values of three values of color information of R (red), G (green), and B (blue) as three primary colors of light, the primitive pixel values express these values of R, G, and B, respectively. Hereinafter, the same is true with the optical display apparatus control program of exemplary embodiment 15 and the optical display apparatus control method of exemplary embodiment 27.

### Exemplary Embodiment 3

Furthermore, an optical display apparatus of exemplary embodiment 3 is characterized in that, in the optical display apparatus according to exemplary embodiment 2, when all of the pixel values for n pixels of the second light modulator device corresponding to one pixel of the first light modulator device are the same,
the first light propagation characteristic control device switches light propagation characteristics of each pixel of the first light modulator device to light propagation characteristics based on the plurality of primitive pixel values obtained by further segmenting the pixel value and maintains the switched light propagation characteristics of interest in time according to the control of the n pixels, and
the second light propagation characteristic control device switch controls light propagation characteristics of the n pixels to light propagation characteristics based on the pixel value according to switching timing of each pixel of the first light modulator device.

When such a constitution is adopted, the first light propagation characteristic control device can switch light propagation characteristics of each pixel of the first light modulator device to light propagation characteristics based on the plurality of primitive pixel values obtained by further segmenting the pixel value and maintain the switched light propagation characteristics of interest in time according to the control of the n pixels, and the second light propagation characteristic control device can switch control light propagation characteristics of the n pixels to light propagation characteristics based on the pixel value according to switching timing of each pixel of the first light modulator device.

Therefore, since, when all of the pixel values of the display image data corresponding to n pixels are the same, the number of times for switching light propagation characteristics of the respective corresponding pixels of the first light modulator device and the second light modulator device can be reduced, the effect that the processing load can be reduced and the brightness reduction due to time-sharing switching control of the corresponding pixel portions can be reduced or prevented, is obtained.

### Exemplary Embodiment 4

Furthermore, an optical display apparatus of exemplary embodiment 4 is characterized in that, in the optical display apparatus according to exemplary embodiment 2 or 3, the first light propagation characteristic control device and the second light propagation characteristic control device perform the switch control when an image to be displayed is a still image.

When such a constitution is adopted, the first light propagation characteristic control device and the second light propagation characteristic control device perform the switch control when an image to be displayed is a still image.

Therefore, an image is displayed with resolution of the first light modulator device by performing the switch control only when the display image data is for a still image, while making pixels of the first light modulator device to correspond to the pixels of the second light modulator device one-one-one in the case where the display image data is for a moving image, and thereby, the effect that the processing load can be reduced when the display image is a moving image and, on the other hand, when the display image is a still image, the image can be displayed with high image quality is obtained.

Here, the still image is not limited to the case where the image data itself is for a still image, but includes the case where data in a certain area does not change in moving image data as the still image.

### Exemplary Embodiment 5

Furthermore, an optical display apparatus of exemplary embodiment 5 is characterized in that, in the optical display apparatus according to any one of exemplary embodiments 2 to 4, the first light propagation characteristic control device switches light propagation characteristics in response to the primitive pixel values in each pixel of the first light modulator device to characteristics with propagation efficiency higher than light propagation efficiency of pixels of the second light modulator device corresponding to each pixel of interest based on the display image data.

When such a constitution is adopted, the first light propagation characteristic control device can switch light propagation characteristics in response to the primitive pixel values in each pixel of the first light modulator device to characteristics with propagation efficiency higher than light propagation efficiency of pixels of the second light modulator device corresponding to each pixel of interest based on the display image data.

Therefore, the effect that the brightness of the display image reduced due to the time-sharing switching control can be compensated by raising the light propagation efficiency of the respective pixels of the first light modulator device.

### Exemplary Embodiment 6

Furthermore, an optical display apparatus of exemplary embodiment 6 is characterized in that, in the optical display apparatus according to any one of exemplary embodiments 2 to 4, the second light propagation characteristic control device switches light propagation characteristics in response to the pixel values for controlling the second light modulator device of the pixels in the second light modulator device to characteristics with propagation efficiency higher than light propagation efficiency of the pixel of the first light modulator device corresponding to the pixels of interest based on the display image data.

When such a constitution is adopted, the second light propagation characteristic control device can switch light propagation characteristics in response to the pixel values for controlling the second light modulator device of the pixels in the second light modulator device to characteristics with propagation efficiency higher than light propagation efficiency of pixels of the first light modulator device corresponding to the pixels of interest based on the display image data.

Therefore, the effect that the brightness of the display image reduced due to the time-sharing switching control can be compensated by raising the light propagation efficiency of the pixels of the second light modulator device.

### Exemplary Embodiment 7

Furthermore, an optical display apparatus of the exemplary embodiment 7 is characterized in that, in the optical display apparatus according to any one of exemplary embodiment 2 to 6, both the first light modulator device and the second light modulator device have the pixels arranged in a matrix form, and the number of pixels of the second light modulator device is an integral number times the number of pixels of the first light modulator device both in row and column directions, and, with respect to each pixel of the first light modulator device, the pixel of interest regularly and optically corresponds to n pixels of the second light modulator device.

When such a constitution is adopted, since each pixel of the first light modulator device regularly corresponds to n pixels of the second light modulator device, switching processing can be performed simply, and, in addition to speeding up of the processing, the effect that the cost can be reduced by the simplification of the circuit configuration and optical configuration or the like is obtained.

### Exemplary Embodiment 8

Furthermore, an optical display apparatus of exemplary embodiment 8 is characterized by, in the optical display apparatus according to exemplary embodiment 7, further including a plurality of the first light modulator devices corresponding to lights in a plurality of different wavelength ranges,
wherein, with respect to each pixel of each of the first light modulator device, the pixel of interest regularly and optically corresponds to n pixels of the second light modulator device.

When such a constitution is adopted, for example, since each pixel of plural first light modulator devices respectively corresponding to plural lights in the different wavelength ranges as the respective color lights of three primary colors of light regularly corresponds to n pixels of the second light modulator device, in display of a color image, compared to the case of using one first light modulator device formed by rotary color filters or the like, because three color lights can be separately modulated by the first light modulator devices, the processing speed can be enhanced, and further, since a related art liquid crystal display device (LCD, liquid crystal light valve, or the like) can be diverted for the second light modulator device, the effect that the cost can be reduced is obtained.

### Exemplary Embodiment 9

Furthermore, an optical display apparatus of exemplary embodiment 9 is characterized in that, in the optical display apparatus according to exemplary embodiment 7 or 8, the number of pixels in the column direction of the second light modulator device is twice the number of pixels in the column direction of the first light modulator device, and
the second light propagation characteristic control device performs the switch control processing of light propagation characteristics in response to the pixel values of the display image data in order from one of even rows or odd rows of the second light modulator device and, during performance of the switch control of interest, switches the light propagation characteristics of pixels in the other rows to characteristics for providing the lowest or substantially the lowest light propagation efficiency.

When such a constitution is adopted, the second light propagation characteristic control device can perform the switch control processing in order from one of even rows or odd rows of the second light modulator device and, during performance of the switch control of interest, switch the light propagation characteristics of pixels in the other rows to characteristics for providing the lowest or substantially the lowest light propagation efficiency.

Therefore, in the second light modulator device, since light modulation processing can be performed by the same procedure as for the interlace scanning, even when the display resolution is doubled, image display can be performed by performing the same speed operation twice, and thereby, the effect that the cost can be reduced by the simplification of the circuit configuration and the optical configuration is obtained.

Further, since an image is displayed by the same procedure as for the interlace scanning, the effect that the image quality in display of a moving image can be enhanced, is obtained.

Further, since the matching with interlace signals becomes better, the image quality at the time of image display by the interlace video signals is enhanced.

### Exemplary Embodiment 10

Furthermore, an optical display apparatus of exemplary embodiment 10 is characterized in that, in the optical display apparatus according to exemplary embodiments 7 or 8, the number of pixels in the row direction of the second light modulator device is twice the number of pixels in the row direction of the first light modulator device, and
the second light propagation characteristic control device performs the switch control processing of light propagation characteristics in response to the pixel values of the display image data in order from one of even columns or odd columns of the second light modulator device and, during performance of the switch control of interest, switches the light propagation characteristics of pixels in the other columns to characteristics for providing the lowest or substantially the lowest light propagation efficiency.

When such a constitution is adopted, the second light propagation characteristic control device can perform the switch control processing in order from one of even columns or odd columns of the second light modulator device and, during performance of the switch control of interest, switch the light propagation characteristics of pixels in the other columns to characteristics for providing the lowest or substantially the lowest light propagation efficiency.

Therefore, in the second light modulator device, since light modulation processing can be performed by the same procedure as for the interlace scanning, even when the display resolution becomes twice, image display can be performed by performing the same speed operation twice, and thereby, the effect that the cost can be reduced by the simplification of the circuit configuration and the optical configuration is obtained.

Further, since an image is displayed by the same procedure as for the interlace scanning, the effect that the image quality in display of a moving image can be enhanced, is obtained.

Further, since the matching with interlace signals becomes better, the image quality at the time of image display by the interlace video signals is enhanced.

### Exemplary Embodiment 11

Furthermore, an optical display apparatus of exemplary embodiment 11 is characterized in that, in the optical display apparatus according to any one of exemplary embodiments 2 to 10, the second light modulator device is a liquid crystal display device.

When such a constitution is adopted, since a panel formed by detaching a color filter from a related art LCD panel with color filter, or a panel formed by replacing a color filter of a related art LCD panel with color filter by a monochrome filter can be diverted for the second light modulator device, the effect that the cost can be reduced is obtained.

### Exemplary Embodiment 12

On the other hand, in order to address or accomplish the above described object, a light modulating apparatus of exemplary embodiment 12 is an apparatus applied to an optical system including a light modulator device having a plurality of pixels with independently controllable light propagation characteristics and a brightness adjuster light source having a plurality of light sources with independently adjustable brightness for making the pixels of the light modulator device optically correspond to the light sources of the brightness adjuster light source at a ratio of 1: n (n is an integral number equal to or more than 2) and modulating light from the brightness adjuster light source via the light modulator device, the apparatus characterized by
setting a plurality of kinds of control patterns in which part of n light sources of the brightness adjuster light source are turned on at predetermined brightness and the rest are not turned on, and
controlling n light sources of the brightness adjuster light source corresponding to one pixel of the light modulator device with one of the plurality of kinds of control patterns and switching the control pattern of n light sources of the brightness adjuster light source corresponding to each of the pixels according to switching timing of the light propagation characteristics of each pixel of the light modulator device.

When such a constitution is adopted, the light propagation characteristics of each pixel of the light modulator device can be switched to predetermined characteristics in a time-sharing manner, and the brightness of n light sources corresponding to each pixel of interest can be switched to one of the plural kinds of control patterns according to switching timing of the light propagation characteristics of each of the pixels.

Therefore, by switching the brightness of n light sources in the brightness modulator light source to suitable control patterns with respect to each light source according to the switching timing of the light propagation characteristics of each pixel, the effect that an optical image formed by light with resolution (the number of light sources) that the brightness modulator light source has can be transmitted to a target position is obtained.

Further, since the light of the light source is modulated in two stages by the brightness modulator light source and the light modulator device, the effect that relatively high brightness dynamic range and number of levels of gray can be realized is obtained.

Further, the brightness modulator light source includes a light source formed by a light source with adjustable brightness such as an LED (Light Emitting Diode), an OLED (Organic Light Emitting Diode), and a fluorescent lamp. Hereinafter, the same is true with the optical display apparatus of exemplary embodiment 13, the light modulation control program of exemplary embodiments 24 and 25, and the light modulation control method of exemplary embodiments 37 and 38.

Further, the switching processing to predetermined brightness for a predetermined number of light sources includes a combination in which all of n light sources are turned off according to the switching timing of each pixel of the light modulator device. Hereinafter, the same is true with the light modulation control program of exemplary embodiment 24 and the light modulation control method of exemplary embodiment 37.

### Exemplary Embodiment 13

On the other hand, in order to accomplish the above described object, a light modulating apparatus of exemplary embodiment 13 is an apparatus applied to an optical system including a brightness adjuster light source having a plurality of light sources with independently adjustable brightness and a light modulator device having a plurality of pixels with independently controllable light propagation characteristics for making the light sources of the brightness adjuster light source optically correspond to the pixels of the light modulator device at a ratio of 1: n (n is an integral number equal to or more than 2) and modulating light from the brightness adjuster light source via the light modulator device, the apparatus characterized by
setting a plurality of kinds of control patterns in which part of n pixels of the light modulator device are made to have predetermined light propagation characteristics and the rest are made to have light propagation characteristics for providing the lowest or substantially the lowest light propagation efficiency, and
controlling n pixels of the light modulator device corresponding to one light source of the brightness adjuster light source with one of the plurality of kinds of control patterns and switching the control pattern of n pixels of the light modulator device corresponding to each of the light sources according to switching timing of brightness of each light source of the brightness adjuster light source.

When such a constitution is adopted, the brightness of each light source of the brightness adjuster light source can be switched in a time-sharing manner, and the light propagation characteristics of n pixels corresponding to each light source of interest can be switched to predetermined characteristics according to switching timing of brightness of each light source.

Therefore, by switching the light propagation characteristics of n pixels corresponding to each light source to suitable control patterns according to the switching timing of each light source, the effect that an optical image formed by light with resolution (the number of pixels) that the light modulator device has can be transmitted to a target position is obtained.

Further, since the light of the light source is modulated in two stages by the brightness modulator light source and the light modulator device, the effect that relatively high brightness dynamic range and number of levels of gray can be realized is obtained.

Further, the plurality of kinds of control patterns include a combination in which all of predetermined number of pixels are made to have light propagation characteristics for providing the lowest or substantially the lowest light propagation efficiency according to the switching timing of each light source of the brightness modulation light source. Hereinafter, the same is true with the light modulation control program of exemplary embodiment 25 and the light modulation control method of exemplary embodiment 38.

### Exemplary Embodiment 14

On the other hand, in order to accomplish the above described object, a light modulation control program of exemplary embodiment 14 is a program applied to an optical system including a first light modulator device having a plurality of pixels with independently controllable light propagation characteristics and a second light modulator device having a larger number of pixels than the first light modulator device with independently controllable light propagation characteristics for making the pixels of the first light modulator device optically correspond to the pixels of the second light modulator device at a ratio of 1: n (n is an integral number equal to or more than 2) and modulating light from a light source via the first light modulator device and the second light modulator device, the program characterized by
setting a plurality of kinds of control patterns in which part of n pixels of the second light modulator device are made to have predetermined light propagation characteristics and the rest are made to have light propagation characteristics for providing the lowest or substantially the lowest light propagation efficiency, and
controlling n pixels of the second light modulator device corresponding to one pixel of the first light modulator device with one of the plurality of kinds of control patterns and switching the control pattern of the pixels of the second light modulator device according to switching timing of the light propagation characteristics of the pixel of the first light modulator device.

Here, exemplary embodiment of the invention is a program applicable to the light modulating apparatus of exemplary embodiment 1, and thereby, the equal effect to the light modulating apparatus of exemplary embodiment 1 is obtained.

### Exemplary Embodiment 15

On the other hand, in order to accomplish the above described object, an optical display apparatus control program of exemplary embodiment 15 is a program for controlling an optical display apparatus including a first light modulator device having a plurality of pixels with independently controllable light propagation characteristics and a second light modulator device having a plurality of pixels with independently controllable light propagation characteristics for making the pixels of the first light modulator device optically correspond to the pixels of the second light modulator device at a ratio of 1: n (n is an integral number equal to or more than 2) and displaying an image by modulating light from the light source via the first light modulator device and the second light modulator device, the program characterized by
segmenting a pixel value corresponding to one pixel of display image data into a pixel value for controlling the first light modulator device and a pixel value for controlling the second light modulator device, respectively, and further segmenting the pixel value for controlling the first light modulator device into a plurality of primitive pixel values,
setting a plurality of kinds of control patterns in which part of n pixels of the second light modulator device are made to have predetermined light propagation characteristics and the rest are made to have light propagation characteristics for providing the lowest or substantially the lowest light propagation efficiency based on the pixel value for controlling the second light modulator device, and
allowing a computer to execute processing realized as:
a first light propagation characteristic control device for switch controlling the light propagation characteristics of the pixel of the first light modulator device in a time-sharing manner based on the respective primitive pixel values for controlling the first light modulator device; and
a second light propagation characteristic control device for switch controlling the control pattern of the pixels of the second light modulator device according to switching timing of the light propagation characteristics of the pixel of the first light modulator device.

Here, exemplary embodiment of the invention is a program applicable to the optical display apparatus of exemplary embodiment 2, and thereby, the equal effect to the optical display apparatus of exemplary embodiment 2 is obtained.

### Exemplary Embodiment 16

Furthermore, an optical display apparatus control program of exemplary embodiment 16 is characterized in that, in the optical display apparatus control program according to exemplary embodiment 15, when all of the pixel values for n pixels of the second light modulator device corresponding to one pixel of the first light modulator device are the same,
the first light propagation characteristic control device switches light propagation characteristics of each pixel of the first light modulator device to light propagation characteristics based on the plurality of primitive pixel values obtained by further segmenting the pixel value and maintain the switched light propagation characteristics of interest in time according to the control of the n pixels, and
the second light propagation characteristic control device switch controls light propagation characteristics of the n pixels to light propagation characteristics based on the pixel values according to switching timing of each pixel of the first light modulator device.

Here, exemplary embodiment of the invention is a program applicable to the optical display apparatus of exemplary embodiment 3, and thereby, the equal effect to the optical display apparatus of exemplary embodiment 3 is obtained.

### Exemplary Embodiment 17

Furthermore, an optical display apparatus control program of exemplary embodiment 17 is characterized in that, in the optical display apparatus control program according to exemplary embodiments 15 or 16, the first light propagation characteristic control device and the second light propagation characteristic control device perform the switch control when an image to be displayed is a still image.

Here, exemplary embodiment of the invention is a program applicable to the optical display apparatus of exemplary embodiment 4, and thereby, the equal effect to the optical display apparatus of exemplary embodiment 4 is obtained.

### Exemplary Embodiment 18

Furthermore, an optical display apparatus control program of exemplary embodiment 18 is characterized in that, in the optical display apparatus control program according to any one of exemplary embodiments 15 to 17, the first light propagation characteristic control device switches light propagation characteristics in response to the primitive pixel values in each pixel of the first light modulator device to characteristics with propagation efficiency higher than light propagation efficiency of pixels of the second light modulator device corresponding to each pixel of interest based on the display image data.

Here, exemplary embodiment of the invention is a program applicable to the optical display apparatus of exemplary embodiment 5, and thereby, the equal effect to the optical display apparatus of exemplary embodiment 5 is obtained.

### Exemplary Embodiment 19

Furthermore, an optical display apparatus control program of exemplary embodiment 19 is characterized in that, in the optical display apparatus control program according to any one of exemplary embodiments 15 to 17, the second light propagation characteristic control device switches light propagation characteristics in response to the pixel values for controlling the second light modulator device of the pixels in the second light modulator device to characteristics with propagation efficiency higher than light propagation efficiency of the pixel of the first light modulator device corresponding to the pixels of interest based on the display image data.

Here, exemplary embodiment of the invention is a program applicable to the optical display apparatus of exemplary embodiment 6, and thereby, the equal effect to the optical display apparatus of exemplary embodiment 6 is obtained.

### Exemplary Embodiment 20

Furthermore, an optical display apparatus control program of exemplary embodiment 20 is characterized in that, in the optical display apparatus control program according to any one of exemplary embodiments 15 to 19, both the first light modulator device and the second light modulator device have the pixels arranged in a matrix form, and the number of pixels of the second light modulator device is an integral number times the number of pixels of the first light modulator device both in row and column directions, and, with respect to each pixel of the first light modulator device, the pixel of interest regularly and optically corresponds to n pixels of the second light modulator device.

Here, exemplary embodiment of the invention is a program applicable to the optical display apparatus of exemplary embodiment 7, and thereby, the equal effect to the optical display apparatus of exemplary embodiment 7 is obtained.

### Exemplary Embodiment 21

Furthermore, an optical display apparatus control program of exemplary embodiment 21 is characterized by, in the optical display apparatus control program according to exemplary embodiment 20, further including a plurality of the first light modulator devices corresponding to lights in a plurality of different wavelength ranges,
wherein, with respect to each pixel of each of the first light modulator device, the pixel of interest regularly and optically corresponds to n pixels of the second light modulator device.

Here, exemplary embodiment of the invention is a program applicable to the optical display apparatus of exemplary embodiment 8, and thereby, the equal effect to the optical display apparatus of exemplary embodiment 8 is obtained.

### Exemplary Embodiment 22

Furthermore, an optical display apparatus control program of exemplary embodiment 22 is characterized in that, in the optical display apparatus control program according to exemplary embodiments 20 or 21, the number of pixels in the column direction of the second light modulator device is twice the number of pixels in the column direction of the first light modulator device, and
the second light propagation characteristic control device performs the switch control processing of light propagation characteristics in response to the pixel values of the display image data in order from one of even rows or odd rows of the second light modulator device and, during performance of the switch control of interest, switches the light propagation characteristics of pixels in the other rows to characteristics for providing the lowest or substantially the lowest light propagation efficiency.

Here, exemplary embodiments of the invention is a program applicable to the optical display apparatus of exemplary embodiment 9, and thereby, the equal effect to the optical display apparatus of exemplary embodiment 9 is obtained.

### Exemplary Embodiment 23

Furthermore, an optical display apparatus control program of exemplary embodiment 23 is characterized in that, in the optical display apparatus control program according to exemplary embodiments 20 or 21, the number of pixels in the row direction of the second light modulator device is twice the number of pixels in the row direction of the first light modulator device, and
the second light propagation characteristic control device performs the switch control processing of light propagation characteristics in response to the pixel values of the display image data in order from one of even columns or odd columns of the second light modulator device and, during performance of the switch control of interest, switches the light propagation characteristics of pixels in the other rows to characteristics for providing the lowest or substantially the lowest light propagation efficiency.

Here, exemplary embodiment of the invention is a program applicable to the optical display apparatus of exemplary embodiment 10, and thereby, the equal effect to the optical display apparatus of exemplary embodiment 10 is obtained.

### Exemplary Embodiment 24

On the other hand, in order to accomplish the above described object, a light modulation control program of exemplary embodiment 24 is a program applied to an optical system including a light modulator device having a plurality of pixels with independently controllable light propagation characteristics and a brightness adjuster light source having a plurality of light sources with independently adjustable brightness for making the pixels of the light modulator device optically correspond to the light sources of the brightness adjuster light source at a ratio of 1: n (n is an integral number equal to or more than 2) and modulating light from the brightness adjuster light source via the light modulator device, the program characterized by
setting a plurality of kinds of control patterns in which part of n light sources of the brightness adjuster light source are turned on at predetermined brightness and the rest are not turned on, and
controlling n light sources of the brightness adjuster light source corresponding to one pixel of the light modulator device with one of the plurality of kinds of control patterns and switching the control pattern of n light sources of the brightness adjuster light source corresponding to each of the pixels according to switching timing of the light propagation characteristics of each pixel of the light modulator device.

Here, exemplary embodiment of the invention is a program applicable to the light modulating apparatus of exemplary embodiment 12, and thereby, the equal effect to the light modulating apparatus of exemplary embodiment 12 is obtained.

### Exemplary Embodiment 25

On the other hand, in order to accomplish the above described object, a light modulation control program of exemplary embodiment 25 is a program applied to an optical system including a brightness adjuster light source having a plurality of light sources with independently adjustable brightness and a light modulator device having a plurality of pixels with independently controllable light propagation characteristics for making the light sources of the brightness adjuster light source optically correspond to the pixels of the light modulator device at a ratio of 1: n (n is an integral number equal to or more than 2) and modulating light from the brightness adjuster light source via the light modulator device, the program characterized by
setting a plurality of kinds of control patterns in which part of n pixels of the light modulator device are made to have predetermined light propagation characteristics and the rest are made to have light propagation characteristics for providing the lowest or substantially the lowest light propagation efficiency, and
controlling n pixels of the light modulator device corresponding to one light source of the brightness adjuster light source with one of the plurality of kinds of control patterns and switching the control pattern of n pixels of the light modulator device corresponding to each of the light sources according to switching timing of brightness of each light source of the brightness adjuster light source.

Here, exemplary embodiment of the invention is a program applicable to the light modulating apparatus of exemplary embodiment 13, and thereby, the equal effect to the light modulating apparatus of exemplary embodiment 13 is obtained.

### Exemplary Embodiment 26

On the other hand, in order to accomplish the above described object, a light modulation control method of exemplary embodiment 26 is a method applied to an optical system including a first light modulator device having a plurality of pixels with independently controllable light propagation characteristics and a second light modulator device having a larger number of pixels than the first light modulator device with independently controllable light propagation characteristics for making the pixels of the first light modulator device optically correspond to the pixels of the second light modulator device at a ratio of 1: n (n is an integral number equal to or more than 2) and modulating light from a light source via the first light modulator device and the second light modulator device, the method characterized by
setting a plurality of kinds of control patterns in which part of n pixels of the second light modulator device are made to have a predetermined light propagation characteristic and the rest are made to have light propagation characteristics for providing the lowest or substantially the lowest light propagation efficiency, and
controlling n pixels of the second light modulator device corresponding to one pixel of the first light modulator device with one of the plurality of kinds of control patterns and switching the control pattern of the pixels of the second light modulator device according to switching timing of the light propagation characteristics of the pixel of the first light modulator device.

Thereby, the equal effect to the light modulating apparatus of exemplary embodiment 1 is obtained.

### Exemplary Embodiment 27

On the other hand, in order to accomplish the above described object, an optical display apparatus control method of exemplary embodiment 27 is a method for controlling an optical display apparatus including a first light modulator device having a plurality of pixels with independently controllable light propagation characteristics and a second light modulator device having a plurality of pixels with independently controllable light propagation characteristics for making the pixels of the first light modulator device optically correspond to the pixels of the second light modulator device at a ratio of 1: n (n is an integral number equal to or more than 2) and displaying an image by modulating light from a light source via the first light modulator device and the second light modulator device, the method characterized by
segmenting a pixel value corresponding to one pixel of display image data into a pixel value for controlling the first light modulator device and a pixel value for controlling the second light modulator device, respectively, and further segmenting the pixel value for controlling the first light modulator device into a plurality of primitive pixel values,
setting a plurality of kinds of control patterns in which part of n pixels of the second light modulator device are made to have predetermined light propagation characteristics and the rest are made to have light propagation characteristics for providing the lowest or substantially the lowest light propagation efficiency based on the pixel value for controlling the second light modulator device, and
including:
switch controlling the light propagation characteristics of the pixel of the first light modulator device in a time-sharing manner based on the respective primitive pixel values for controlling the first light modulator device; and
switch controlling the control pattern of the pixels of the second light modulator device according to switching timing of the light propagation characteristics of the pixel of the first light modulator device.

Thereby, the equal effect to the optical display apparatus of exemplary embodiment 2 is obtained.

### Exemplary Embodiment 28

Furthermore, an optical display apparatus control method of exemplary embodiment 28 is characterized in that, in the optical display apparatus control method according to exemplary embodiment 27, when all of the pixel values for n pixels of the second light modulator device corresponding to one pixel of the first light modulator device are the same,
in the first light propagation characteristic control, light propagation characteristics of each pixel of the first light modulator device are switched to light propagation characteristics based on the plurality of primitive pixel values obtained by further segmenting the pixel value and the switched light propagation characteristics of interest are maintained in time according to the control of the n pixels, and
in the second light propagation characteristic control, light propagation characteristics of the n pixels are switch controlled to light propagation characteristics based on the pixel value according to switching timing of each pixel of the first light modulator device.

Thereby, the equal effect to the optical display apparatus of exemplary embodiment 3 is obtained.

### Exemplary Embodiment 29

Furthermore, an optical display apparatus control method of exemplary embodiment 29 is characterized in that, in the optical display apparatus control method according to exemplary embodiments 27 or 28, in the first light propagation characteristic control and the second light propagation characteristic control, the switch control is performed when an image to be displayed is a still image.

Thereby, the equal effect to the optical display apparatus of exemplary embodiment 4 is obtained.

### Exemplary Embodiment 30

Furthermore, an optical display apparatus control method of exemplary embodiment 30 is characterized in that, in the optical display apparatus control method according to any one of the exemplary embodiments 27 to 29, in the first light propagation characteristic control, light propagation characteristics in response to the primitive pixel values in each pixel of the first light modulator device are switched to characteristics with propagation efficiency higher than light propagation efficiency of pixels of the second light modulator device corresponding to each pixel of interest based on the display image data.

Thereby, the equal effect to the optical display apparatus of exemplary embodiment 5 is obtained.

### Exemplary Embodiment 31

Furthermore, an optical display apparatus control method of exemplary embodiment 31 is characterized in that, in the optical display apparatus control method according to any one of exemplary embodiments 27 to 30, in the second light propagation characteristic control, light propagation characteristics in response to the pixel values for controlling the second light modulator device of the pixels in the second light modulator device are switched to characteristics with propagation efficiency higher than light propagation efficiency of the pixel of the first light modulator device corresponding to the pixels of interest based on the display image data.

Thereby, the equal effect to the optical display apparatus of exemplary embodiment 6 is obtained.

### Exemplary Embodiment 32

Furthermore, an optical display apparatus control method of exemplary embodiment 32 is characterized in that, in the optical display apparatus control method according to any one of exemplary embodiments 27 to 31, both the first light modulator device and the second light modulator device have the pixels arranged in a matrix form, and the number of pixels of the second light modulator device is an integral number times the number of pixels of the first light modulator device both in row and column directions, and, with respect to each pixel of the first light modulator device, the pixel of interest regularly and optically corresponds to n pixels of the second light modulator device.

Thereby, the equal effect to the optical display apparatus of exemplary embodiment 7 is obtained.

### Exemplary Embodiment 33

Furthermore, an optical display apparatus control method of exemplary embodiment 33 is characterized by, in the optical display apparatus control method according to exemplary embodiment 32, further including a plurality of the first light modulator devices corresponding to lights in a plurality of different wavelength ranges,
wherein, with respect to each pixel of each of the first light modulator device, the pixel of interest regularly and optically corresponds to n pixels of the second light modulator device.

Thereby, the equal effect to the optical display apparatus of exemplary embodiment 8 is obtained.

### Exemplary Embodiment 34

Furthermore, an optical display apparatus control method of exemplary embodiment 34 is characterized in that, in the optical display apparatus control method according to exemplary embodiments 31 or 32, the number of pixels in the column direction of the second light modulator device is twice the number of pixels in the column direction of the first light modulator device, and
in the second light propagation characteristic control, the switch control processing of light propagation characteristics in response to the pixel values of the display image data is performed in order from one of even rows or odd rows of the second light modulator device and, during performance of the switch control of interest, the light propagation characteristics of pixels in the other rows are switched to characteristics for providing the lowest or substantially the lowest light propagation efficiency.

Thereby, the equal effect to the optical display apparatus of exemplary embodiment 9 is obtained.

### Exemplary Embodiment 35

Furthermore, an optical display apparatus control method of exemplary embodiment 35 is characterized in that, in the optical display apparatus control method according to exemplary embodiments 31 or 32, the number of pixels in the row direction of the second light modulator device is twice the number of pixels in the row direction of the first light modulator device, and
in the second light propagation characteristic control, the switch control processing of light propagation characteristics in response to the pixel values of the display image data is performed in order from one of even columns or odd columns of the second light modulator device and, during performance of the switch control of interest, the light propagation characteristics of pixels in the other columns are switched to characteristics for providing the lowest or substantially the lowest light propagation efficiency.

Thereby, the equal effect to the optical display apparatus of exemplary embodiment 10 is obtained.

### Exemplary Embodiment 36

Furthermore, an optical display apparatus control method of exemplary embodiment 36 is characterized in that, in the optical display apparatus control method according to exemplary embodiments 31 or 32, the second light modulator device is a liquid crystal display device.

Thereby, the equal effect to the optical display apparatus of exemplary embodiment 11 is obtained.

### Exemplary Embodiment 37

On the other hand, in order to accomplish the above described object, a light modulation control method of exemplary embodiment 37 is a method applied to an optical system including a light modulator device having a plurality of pixels with independently controllable light propagation characteristics and a brightness adjuster light source having a plurality of light sources with independently adjustable brightness for making the pixels of the light modulator device optically correspond to the light sources of the brightness adjuster light source at a ratio of 1: n, where n is an integral number equal to or more than 2, and modulating light from the brightness adjuster light source via the light modulator device, the method characterized by
setting a plurality of kinds of control patterns in which part of n light sources of the brightness adjuster light source are turned on at predetermined brightness and the rest are not turned on, and
controlling n light sources of the brightness adjuster light source corresponding to one pixel of the light modulator device with one of the plurality of kinds of control patterns and switching the control pattern of n light sources of the brightness adjuster light source corresponding to each of the pixels according to switching timing of the light propagation characteristics of each pixel of the light modulator device.

Thereby, the equal effect to the light modulating apparatus of exemplary embodiment 12 is obtained.

### Exemplary Embodiment 38

On the other hand, in order to accomplish the above described object, a light modulation control method of exemplary embodiment 38 is a method applied to an optical system including a brightness adjuster light source having a plurality of light sources with independently adjustable brightness and a light modulator device having a plurality of pixels with independently controllable light propagation characteristics for making the light sources of the brightness adjuster light source optically correspond to the pixels of the light modulator device at a ratio of 1: n (n is an integral number equal to or more than 2) and modulating light from the brightness adjuster light source via the light modulator device, the method characterized by
setting a plurality of kinds of control patterns in which part of n pixels of the light modulator device are made to have predetermined light propagation characteristics and the rest are made to have light propagation characteristics for providing the lowest or substantially the lowest light propagation efficiency, and
controlling n pixels of the light modulator device corresponding to one light source of the brightness adjuster light source with one of the plurality of kinds of control patterns and switching the control pattern of n pixels of the light modulator device corresponding to each of the light sources according to switching timing of brightness of each light source of the brightness adjuster light source.

Thereby, the equal effect to the light modulating apparatus of exemplary embodiment 13 is obtained.

### BRIEF DESCRIPTION OF THE DRAWINGS

FIG. 1 is a schematic showing the principal optical configuration of a projection display apparatus 100 according to exemplary embodiments of the invention;

FIG. 2 is a schematic block diagram showing the principal optical configuration of a display control device 200;

FIG. 3(a) is a schematic showing the configuration of the pixel surface of the color modulator light valve, and (b) is a schematic showing the configuration of the pixel surface of the brightness modulator light valve;

FIG. 4 is a flowchart showing display control processing;

FIG. 5 is a schematic showing tone mapping processing;

FIG. 6 is a timing chart of switching processing of transmittances;

FIG. 7 is a schematic showing display results of images in the brightness modulator light valve;

FIG. 8(a) is a schematic showing the correspondence of the respective pixels of the brightness modulator light valve to the pixel values of the display image data, (b) is a schematic showing details on switching of transmittances at the color modulator light valve side in response to the display contents in (a), (c) is a schematic showing details on switching of transmittances at the brightness modulator light valve side in response to the display contents in (a), (d) is a schematic showing display results by the combination of switching processing in (b) and (c), (e) is a schematic showing an example of performing processing of compensating for brightness at the color modulator light valve side, and (f) shows an example of performing processing of compensating for brightness at the brightness modulator light valve side;

FIG. 9 is a schematic showing the principal optical configuration of a direct-view display system 300;

FIG. 10 is a schematic showing the principal optical configuration of the direct-view display system 300;

FIG. 11 is a schematic showing the principal optical configuration of a display 400;

FIG. 12 is a schematic showing the principal optical configuration when the brightness modulator light valve is disposed in the precedent stage of the color modulator light valves in the projection display apparatus 100;

FIG. 13 is a schematic showing a flow of display processing of HDR images in the modified example 3;

FIG. 14 is a schematic showing a principal optical configuration when the projection display apparatus 100 is formed by providing the relay lens 50 between the brightness modulator unit 12 and the color modulator unit 14; and

FIG. 15 is a schematic showing a principal optical configuration when the projection display apparatus 100 is formed as a single LCD system.

### DETAILED DESCRIPTION OF PREFERRED EMBODIMENTS

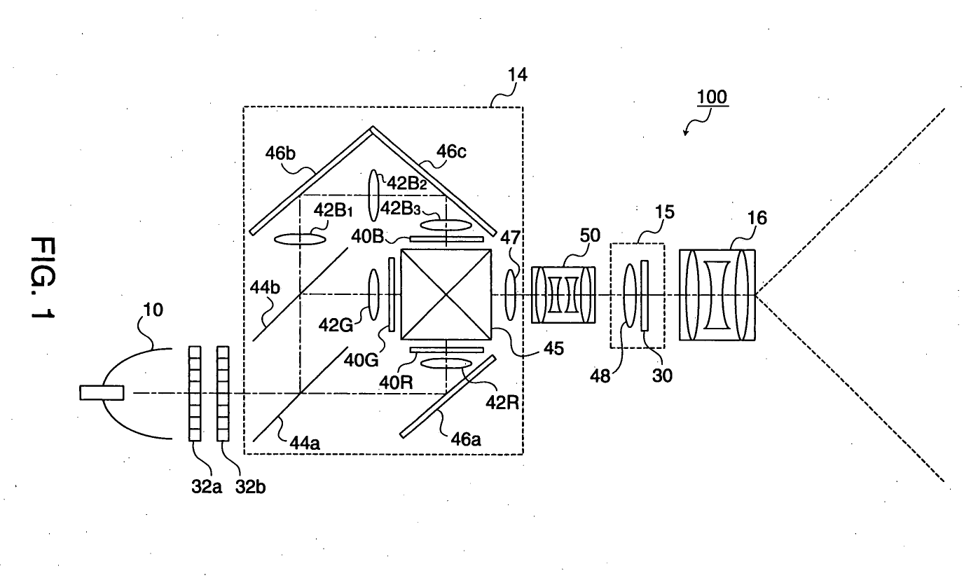

Hereinafter, exemplary embodiments of the invention will be described according to the drawings. FIGS. 1 to 15 are schematic diagrams showing the exemplary embodiments of a light modulating apparatus, an optical display apparatus, a light modulation control program, an optical display apparatus control program, a light modulation control method, and an optical display apparatus control method according to exemplary embodiment of the invention.

This exemplary embodiment is an application of the light modulating apparatus, the optical display apparatus, the light modulation control program, the optical display apparatus control program, the light modulation control method, and the optical display apparatus control method according to exemplary embodiment of the invention to a projection display apparatus 100 as shown in FIG. 1.

First, the constitution of the projection display apparatus 100 will be described according to FIG. 1.

FIG. 1 is a schematic block diagram showing a principal optical configuration of the projection display apparatus 100.

As shown in FIG. 1, the projection display apparatus 100 includes a light source 10 of an ultra high-pressure mercury lamp, a xenon lamp, or the like, two fly-eye lenses 32a and 32b for dispersing brightness irregularities of light from the light source 10 so as to obtain uniform illuminance distribution on an irradiated surface, a color modulator unit 14 for respectively modulating brightness of RGB three primary colors of wavelength ranges of light entering via the fly-eye lenses 32a and 32b, an entrance side lens 47 for allowing the light entering from the color modulator unit 14 to efficiently enter a relay lens 50, the relay lens 50 for accurately transmitting the light entering via the entrance side lens 47 to a brightness modulator unit 15, which will be described later, in a state in which the intensity distribution thereof is nearly perfectly conserved with almost no light loss, the brightness modulator unit 15 for modulating brightness of all wavelength ranges of light entering via the relay lens 50, and a projector unit 16 for projecting the light entering from the brightness modulator unit 15 onto a screen (not shown).

The color modulator unit 14 includes three liquid crystal light valves 40R, 40G, and 40B (hereinafter, abbreviated to liquid crystal light valves 40R to 40B) each having plural pixels with independently controllable transmittances arranged in a matrix form, five field lenses 42R, 42G, and 42B1 to 42B3, and two dichroic mirrors 44a and 44b, and three mirrors 46a, 46b, and 46c, and a dichroic prism 45.

The brightness modulator unit 15 includes an exit side lens 48 for nearly collimating the light entering via the relay lens 50 to output the light toward a liquid crystal light valve 30 and the liquid crystal light valve 30 having plural pixels with independently controllable transmittances arranged in a matrix form and higher resolution than the liquid crystal light valves 40R, 40G, and 40B.

First, the light entering the color modulator unit 14 via the two fly-eye lenses 32a and 32b is spectrally separated into RGB three primary colors of red, green, and blue by the dichroic mirrors 44a and 44b and entered into the liquid crystal light valves 40R to 40B via the field lenses 42R, 42G, and 42B1 to 42B3, and the mirrors 46a to 46c. Then, the brightness of the spectrally separated lights of RGB three primary colors are modulated by the liquid crystal light valves 40R to 40B, respectively, and the modulated lights of RGB three primary colors are condensed by the dichroic prism 45 and entered into the liquid crystal light valve 30 via the entrance side lens 47, the relay lens 50, and the exit side lens 48. Further, by the liquid crystal light valve 30, the brightness of all wavelength ranges of the incident light is modulated and the light is output to the projector unit 16.

Here, the liquid crystal light valves 30 and 40R to 40B are active matrix liquid crystal display devices each having a TN liquid crystal sandwiched between a glass substrate on which pixel electrodes and switching devices such as thin-film transistor devices or thin-film diodes for driving the electrodes are formed in a matrix form and a glass substrate on which a common electrode is formed over the entire surface, and polarizing plates disposed on the outer surfaces. The intensity of light passing through the liquid crystal light valve can be modulated by changing the transmittance in response to the control value (applied voltage). For example, when a voltage is applied, the white/light (transmitting) condition occurs, while, when no voltage is applied, black/dark (non-transmitting) condition occurs, and, in response to provided control values, the scale of gray therebetween is controlled in an analog fashion. The liquid crystal light valves 30 and 40R to 40B are the same in that any of them modulates the intensity of transmitted light and internally includes an optical image in response to the degree of modulation. However, they differ in that, while the former liquid crystal light valve 30 modulates light in all wavelength ranges (while light), the latter liquid crystal light valves 40R to 40B modulate spectrally separated light in specific wavelength ranges (color lights of R, G, and B). Therefore, as below, the light intensity modulation performed by the liquid crystal light valves 40R to 40B and the light intensity modulation performed by the liquid crystal light valve 30 are distinguished by being referred to as “color modulation” and “brightness modulation”, respectively, for convenience. Further, from the same point of view, the liquid crystal light valves 40R to 40B and the liquid crystal light valve 30 are distinguished by being referred to as “color modulator light valves” and “brightness modulator light valve”, respectively.

The projection display apparatus 100 has a display control device 200 (not shown) for controlling the brightness modulator light valve and the color modulator light valves. In the exemplary embodiment, the brightness modulator light valve has higher resolution than the color modulator light valves, and thus, the brightness modulator light valve determines display resolution (refers to resolution that an observer perceives when the observer sees the display image of the projection display apparatus 100). Needless to add, the relationship with display resolution is not limited to that, but a constitution in which the color modulator light valve determines the display resolution may be adopted. Further, in the exemplary embodiment, both the brightness modulator light valve and the color modulator light valves apply normally black mode liquid crystal light valves that take white/light (transmitting) condition when a voltage is applied and black/dark (non-transmitting) condition when no voltage is applied. Further, an optical image internally included in the light modulated in the liquid crystal light valves 40R to 40B and condensed by the dichroic prism 45 is transmitted to the liquid crystal light valve 30 in the reversed state (inverted image) via the relay optical system formed by the entrance side lens 47, the relay lens 50, and the exit side lens 48.

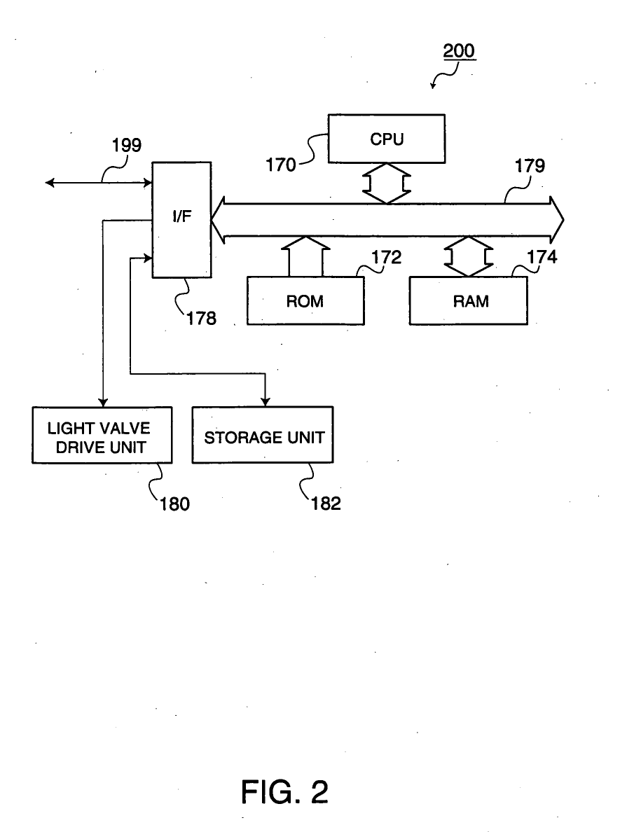

Next, the constitution of the display control device 200 will be described according to FIG. 2.

FIG. 2 is a block diagram showing the hardware configuration of the display control device 200.

As shown in FIG. 2, the display control device 200 includes a CPU 170 for performing operations and controlling the entire system based on control programs, a ROM 172 that has stored in advance the control programs of the CPU 170 in a predetermined area, a RAM 174 for storing data read out from the ROM 172 or the like and operation results necessary for the operation steps in the CPU 170, and an I/F 178 through which data is input to or output from an external unit, and these are mutually connected so as to transmit and receive data by a bus 179 as a signal line for transferring data.

To the I/F 178, as an external unit, a light valve drive unit 180 for driving the brightness modulator light valve (liquid crystal light valve 30) and the color modulator light valves (liquid crystal light valves 40R to 40B), a storage unit 182 for storing data, tables, or the like as files, and a signal line for connection to an external network 199 are connected.

The storage unit 182 has stored HDR display data for driving the brightness modulator light valve and the color modulator light valves.

The HDR display data is image data capable of realizing high brightness dynamic range that can not be realized by a related art image format such as sRGB, and stores pixel values representing brightness levels of pixels with respect to all pixels of an image. In the exemplary embodiment, as the HDR display data, a format in which pixel values representing radiance brightness levels with respect to RGB three primary colors for one pixel as floating point values is used. For example, as pixel values of one pixel, a value (1.2, 5.4, 2.3) has been stored.

By the way, for example, related art document 1, P. E. Debevec, J. Malik, “Recovering High Dynamic Range Radiance Maps from Photographs”, Proceedings of ACM SIGGRAPH97, pp. 367-378 (1997) discloses details on a method for generating HDR display data.

Further, the storage unit 182 has stored a control value registration table in which control values of the color modulator light valves and the brightness modulator light valve are registered.

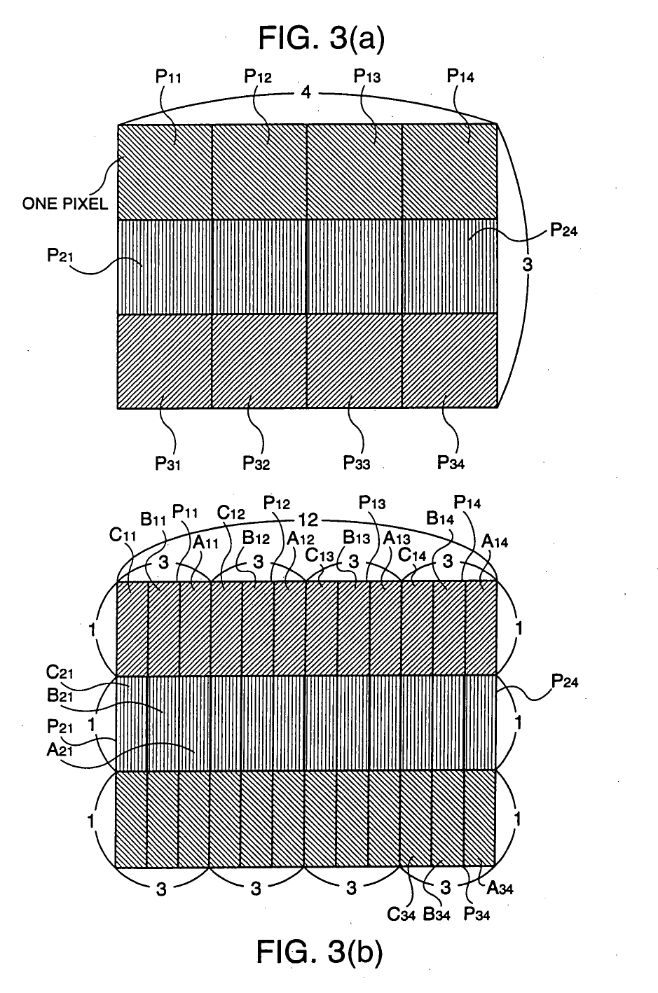

Next, according to FIG. 3, the relationship between pixels of the color modulator light valves and the brightness modulator light valve will be described. FIG. 3(a) shows the configuration of the pixel surface of the color modulator light valve and (b) shows the configuration of the pixel surface of the brightness modulator light valve.

In the exemplary embodiment, for convenience of explanation, as shown in FIG. 3(a), the pixel surface of the color modulator light valve (liquid crystal light valves 40R to 40B) is formed by three pixels high×four pixels wide, and, as shown in FIG. 3(b), the pixel surface of the brightness modulator light valve (liquid crystal light valve 30) is formed by three pixels high×twelve pixels wide. That is, the lateral resolution of the brightness modulator light valve is just three times the lateral resolution of the color modulator light valve.

In the exemplary embodiment, high image quality display of HDR images is performed with the resolution of the brightness modulator light valve by making plural pixels of the brightness modulator light valve optically correspond to each pixel of the color modulator light valve, and switching a transmittance of each pixel of the color modulator light valve and transmittances of corresponding plural pixels of the brightness modulator light valve in a time-sharing manner. Here, one pixel of the color modulator light valve is made to optically correspond to three pixels of the brightness modulator light valve.

Specifically, a pixel P11 of the color modulator light valve shown in FIG. 3(a) is made to optically correspond to a pixel block P34 consisting of pixels A34 to C34 of the brightness modulator light valve shown in FIG. 3(b). Similarly, the pixels P12 to P14, P21 to P24, and P31 to P34 of the color modulator light valve are made to optically correspond to pixel blocks P34 (A33 to C33) to P31 (A32 to C32), P24 (A31 to C31) to P21 (A21 to C21), and P14 (A14 to C14) to P11 (A11 to C11) of the brightness modulator light valve, respectively.

Here, as described above, P11 (upper left) of the color modulator light valve corresponds to P34 (lower right) of the brightness modulator light valve because the optical image formed on the display surface of the brightness modulator light valve becomes an inverted image via the relay optical system formed by the entrance side lens 47, the relay lens 50, and the exit side lens 48.

Next, the constitution of the CPU 170 and the processing executed by the CPU 170 will be described.

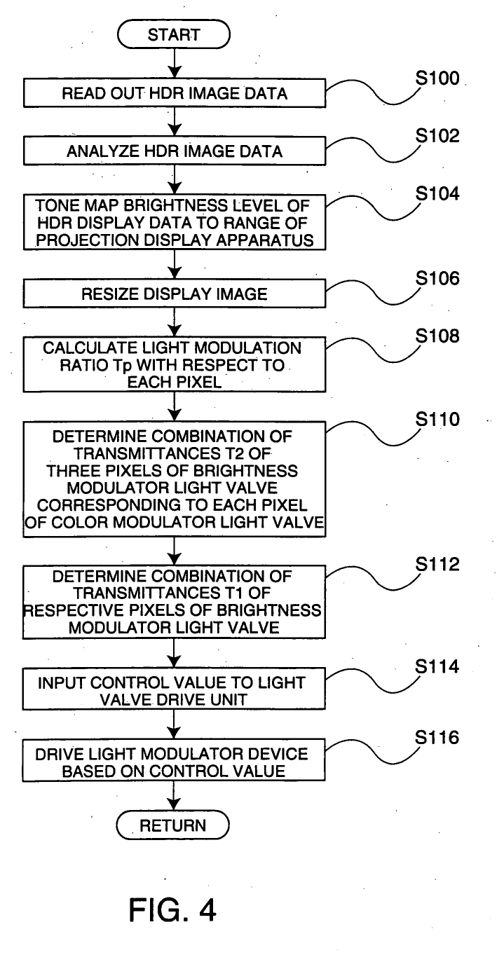

The CPU 170 includes a micro processing unit (MPU) and the like, and is arranged so as to activate a predetermined program stored in a predetermined area of the ROM 172 and execute display control processing shown in a flowchart in FIG. 4 according to the program.

FIG. 4 is the flowchart showing the display control processing.

The display control processing is processing of respectively determining control values of the brightness modulator light valve and the color modulator light valves based on the HDR display data, and driving the brightness modulator light valve and the color modulator light valves based on the determined control values. When executed in the CPU 170, as shown in FIG. 4, first, the process moves to step S100.

In step S100, the HDR display data is read out from the storage unit 182, and the process moves to step S102.

In step S102, the read HDR display data is analyzed and a histogram of pixel values, the maximum value, the minimum value, the average value, etc. of brightness levels are calculated, and the process moves to step S104. Here, the analysis results are used for automatic image correction of making a dark scene brighter, making a too bright scene darker, enhancing intermediate contrast, or the like, or tone mapping.

In step S104, the brightness levels of the HDR display data are tone mapped to the brightness dynamic range of the projection display apparatus 1 based on the analysis results of step S102, and the process moves to step S106.

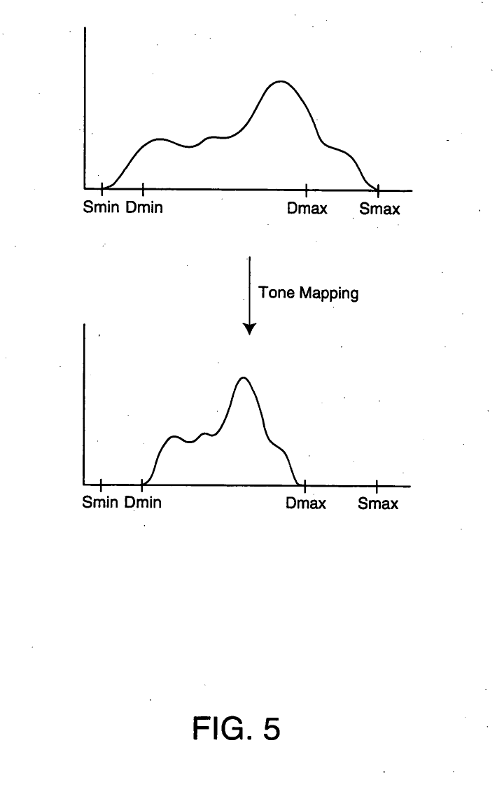

Here, FIG. 5 is a schematic showing the tone mapping processing. As a result of analysis of the HDR display data, given that the minimum value of the brightness levels included in the HDR display data is 5 min and the maximum value is Smax, and further, the minimum value of the brightness dynamic range of the projection display apparatus 1 is Dmin, and the maximum value is Dmax, in the example in FIG. 5, since 5 min is smaller than Dmin and Smax is larger than Dmax, HDR display data can not be displayed appropriately without change. Accordingly, normalization is performed so that the histogram of 5 min to Smax may fit within the range of Dmin to Dmax.

By the way, for example, the related art document 2, F. Drago, K. Myszkowski, T. Annen, N. Chiba, “Adaptive Logarithmic Mapping For Displaying High Contrast Scenes”, Eurographics 2003, (2003) discloses details on tone mapping.

In step S106, an HDR image is resized (enlarged or reduced) according to the resolution of the brightness modulator light valve and the process moves to step S108. Here, the HDR image is resized while holding the aspect ratio of the HDR image. Further, as a resizing method, for example, the average value method, intermediate value method, and nearest neighbor method can be cited.

In step S108, a light modulation rate Tp is calculated with respect to each pixel of the resized image by the above equation (1) based on the brightness level Rp of the pixel of the resized image and the brightness Rs of the light source 10, and the process moves to step S110.

In step S110, with respect to each of plural pixels of the brightness modulator light valve corresponding to each pixel of the color modulator light valve, combinations of transmittances T2 of these plural pixels are determined, and the process moves to step S112. In the exemplary embodiment, since three pixels of the brightness modulator light valve correspond to one pixel of the color modulator light valve, the transmittances are set based on the pixel data (here, referred to as pixel data a to c) of the display image data corresponding to these three pixels. For example, with respect to P34 of the brightness modulator light valve corresponding to P11 of the color modulator light valve, three combinations respectively corresponding to three pixels of the display image data of a combination in which A34 is set to have a transmittance T2A in response to corresponding pixel brightness information of the display image data and the rest B34 and C34 are set to have the lowest transmittance (when no voltage is applied) in the brightness modulator light valve, a combination in which B34 is set to have a transmittance T2B in response to corresponding pixel brightness information of the display image data and the rest A34 and C34 are set to the lowest transmittance in the brightness modulator light valve, and a combination in which C34 is set to have a transmittance T2C in response to corresponding pixel brightness information of the display image data and the rest A34 and B34 are set to the lowest transmittance in the brightness modulator light valve are determined. Hereinafter, the combination of transmittances in the brightness modulator light valve including the transmittance T2A is referred to as T2AS, the combination including the transmittance T2B is referred to as T2BS, and the combination including the transmittance T2C is referred to as T2CS.

In step S112, based on the calculated light modulation rate Tp, the determined transmittances T2A to T2C, and gain G, using the above equation (2), in units of three pixels of the brightness modulator light valve, transmittance T1 of one pixel of the color modulator light valve corresponding to these three pixels is calculated, and the process moves to step S14. Here, the transmittances T1A to T1C corresponding to these three pixels of the brightness modulator light valve are calculated using the T2A to T2C. Here, in the exemplary embodiment, since the projection display apparatus 100 has liquid crystal light valves 40R to 40B respectively corresponding to the respective colors of three primary colors (RGB) as the color modulator light valves, the transmittance T1 is determined with respect to each liquid crystal light valve. Therefore, actually, T1A(R), T1A(G), and T1A(B) (hereinafter, abbreviated to TLA(R) to T1A(B)) to T2A, T1B(R), T1B(G), and T1B(B) (hereinafter, abbreviated to T1B(R) to T1B(B)) to T2B, and T1C(R), T1C(G), and T1C(B) (hereinafter, abbreviated to T1C(R) to T1C(B)) to T2C are determined, respectively.

In step S114, control values corresponding to the T1A to T1C and T2AS to T2CS determined in steps S110 and S112 are read out from the storage unit 182 and input to the light valve drive unit 180, and the process moves to step S116.

In step S116, using the light valve drive unit 180, by switching the transmittance of each pixel of the color modulator light valves in order at predetermined time intervals (e.g., intervals of 1/120 seconds) to each of the calculated T1A to T1C, while switching the transmittances of three pixels of the brightness modulator light valve corresponding to each pixel of the color modulator light valves in order to each of T2AS to T2CS according to the switching timing of the transmittances TIA to TIC of each pixel of the color modulator light valves, the HDR image is projected on a screen via the projector unit 16, and a series of processing is ended and restored to the former processing. Here, the order of switching the transmittances of each pixel of the color modulator light valves and the order of switching the corresponding transmittances of three pixels of the brightness modulator light valve are determined based on the corresponding pixels of the HDR display data.

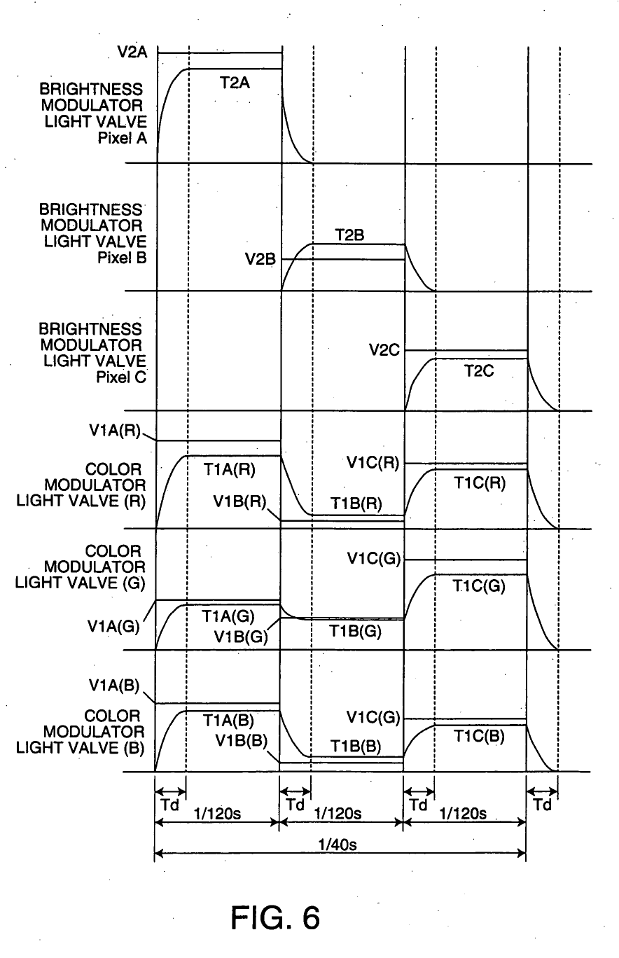

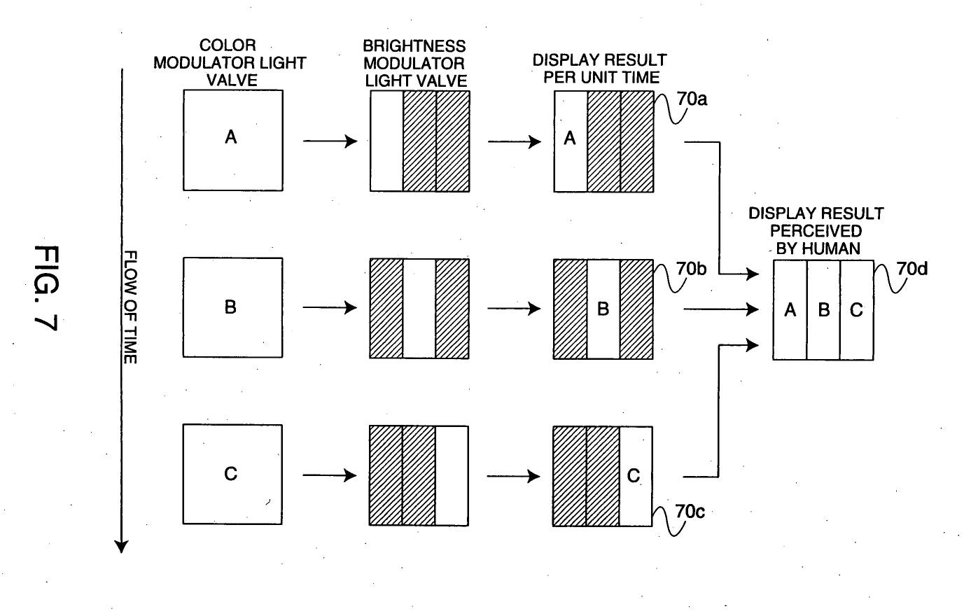

Here, FIG. 6 is a timing chart of the switching processing of transmittances and FIG. 7 is a schematic showing display results of images in the brightness modulator light valve.

As shown in FIG. 6, by the light valve drive unit 180, drive voltages V1A(R) to V1A(B) are respectively applied to the respective pixels of the liquid crystal light valves 40R to 40B so that they may have transmittances T1A(R) to T1A(B) in response to the pixel a of the HDR display data, respectively. On the other hand, regarding the corresponding three pixels of the brightness modulator light valve (here, pixels A to C), a drive voltage V2A is applied to the pixel A corresponding to pixel data a of the HDR display data so that the pixel may have the transmittance T2A, and no drive voltage is applied to the rest pixel B and pixel C. Thereby, transmittances T1A(R) to T1A(B) are set for pixels corresponding to the pixel data a to c of the color modulator light valves (liquid crystal light valves 40R to 40B), and the transmittance T2A is set to the pixel A of the brightness modulator light valve. Here, Td in FIG. 6 indicates time taken for response of liquid crystal, and the liquid crystal takes time Td from being applied with a voltage before its transmittance changes to a desired transmittance.

Then, after a lapse of 1/120 seconds since the drive voltages V1A(R) to V1A(B) and the drive voltage V2A are applied, the drive voltages V1B(R) to V1B(B) are respectively applied to the respective pixels of the liquid crystal light valves 40R to 40B so that they may have transmittances T1B(R) to T1B(B) in response to the pixel b of the HDR display data, respectively. On the other hand, a drive voltage V2B is applied to the pixel B corresponding to pixel data b of the HDR display data so that the pixel may have the transmittance T2B, and no drive voltage is applied to the rest pixel A and pixel C. Thereby, transmittances T1B(R) to T1B(B) are set for pixels corresponding to the pixel data a to c of the color modulator light valves (liquid crystal light valves 40R to 40B), and the transmittance T2B is set for the pixel B of the brightness modulator light valve.

Further, after a lapse of 1/120 seconds since the drive voltages V1B(R) to V1B(B) and the drive voltage V2B are applied, the drive voltages V1C(R) to V1C(B) are respectively applied to the respective pixels of the liquid crystal light valves 40R to 40B so that they may have transmittances T1C(R) to T1C(B) in response to the pixel c of the HDR display data, respectively. On the other hand, a drive voltage V2C is applied to the pixel C corresponding to pixel data c of the HDR display data so that the pixel may have the transmittance T2C, and no drive voltage is applied to the rest pixel A and pixel B. Thereby, transmittances T1C(R) to T1C(B) are set for pixels corresponding to the pixel data a to c of the color modulator light valves (liquid crystal light valves 40R to 40B), and the transmittance T2C is set for the pixel C of the brightness modulator light valve.

As described above, by performing the processing of making only one pixel of the three pixels (pixels A to C) in the brightness modulator light valve into a transmitting condition and the rest two pixels into non-transmitting (the lowest transmittance) condition at intervals as short as 1/120 seconds in the order of pixels A, B, and C, for the human eye, the lights transmitted through the pixels A, B, and C of the brightness modulator light valve are integrated, and thus, the transmitted lights (images A, B, and C) are seen as being displayed simultaneously on the screen.

That is, as shown in FIG. 7, at the first 1/120 seconds, the lights transmitted through the pixels of the color modulator light valves at transmittances T1A(R) to T1A(B) are transmitted through the pixel A of the brightness modulator light valve at the transmittance T2A so as to display display contents shown by 70a in FIG. 7 on the screen. Then at the next 1/120 seconds, the lights transmitted through the pixels of the color modulator light valves at transmittances T1B(R) to T1B(B) are transmitted through the pixel B of the brightness modulator light valve at the transmittance T2B so as to display display contents shown by 70b in FIG. 7 on the screen, and, at the last 1/120 seconds, the lights transmitted through the pixels of the color modulator light valves at transmittances T1C(R) to T1C(B) are transmitted through the pixel C of the brightness modulator light valve at the transmittance T2C so as to display display contents shown by 70c in FIG. 7 on the screen. Since the respective display contents shown by 70a to 70c in FIG. 7 are switched at time intervals as short as 1/120 seconds in order at high speed, when these display contents are seen, they are perceived by a human as display contents shown by 70d in FIG. 7 (all of A, B, and C are displayed) for the reason as described above. Therefore, by performing the processing on all pixels of the brightness modulator light valve, full-color display of HDR images at 1/40 seconds per one frame is realized.

By the way, in the exemplary embodiment, the case where the lateral resolution of the brightness modulator light valve is three times the lateral resolution of the color modulator light valve has been described. However, this scaling factor is not limited to three times, but it may be set to twice or, within the controllable range, four or more times.

Further, in the exemplary embodiment, the example in which the lateral resolution of the brightness modulator light valve is three times the lateral resolution of the color modulator light valve has been described. However, not limited to that, even in the case where the longitudinal resolution of the brightness modulator light valve is higher than the longitudinal resolution of the color modulator light valve, or both the lateral resolution and the longitudinal resolution are higher, the full-color display of HDR images can be realized with the resolution of the brightness modulator light valve by the same processing.

According to the projection display apparatus 100 having the above described constitution, the following effects are exerted. By switching the transmittances of the respective pixels of the color modulator light valves to the transmittances in response to the corresponding three pixel data a to c of the HDR display data at intervals as short as 1/120 seconds in the order of pixels a, b, and c, while performing the processing of making only one pixel of the corresponding three pixels (pixels A to C) in the brightness modulator light valve into a transmitting condition and the rest two pixels into non-transmitting (the lowest transmittance) condition at intervals as short as 1/120 seconds in the order of pixels A, B, and C according to (in synchronization with) the switching timing of the transmittances of the color modulator light valves, the full-color display of HDR images can be realized by the resolution of the brightness modulator light valve.

Further, since the light from the light source 10 is modulated via serially arranged two kinds of light modulator devices (the color modulator light valves and the brightness modulator light valve), the relatively high brightness dynamic range and number of levels of gray can be realized.

By the way, in the case where display images vary as moving images, because the resolution of the human visual perception is relatively reduced, the above described series of display processing may be performed only on still images. Note that, here, the still image is not limited to that the image data itself is of a still image, but includes the case where data in a certain area does not vary in moving image data.

### MODIFIED EXEMPLARY EXAMPLE 1

In the above described exemplary embodiment, even when all of the display contents for the plural pixels (e.g., three pixels) of the brightness modulator light valve corresponding to each pixel of the color modulator light valves are the same, the processing of sequentially switching each pixel of the color modulator light valves and the corresponding plural pixels of the brightness modulator light valve at short time intervals is performed in the same way as described above. However, the algorithm for the display processing is not limited to the method of the above described exemplary embodiment, in the modified exemplary example 1, a function of omitting the switching processing of transmittances when all of the display contents are the same for the plural pixels of the brightness modulator light valve is added to the projection display apparatus 100. Further, in the exemplary embodiment, since the transmittances are switched at short time intervals in a time-sharing manner, for example, in the case where the transmittances for the three pixels are switched at 1/120 seconds in a time-sharing manner, display brightness for these pixels is reduced to one-third. In the modified exemplary example 1, a function of compensating for the display brightness that is reduced by the switching processing of transmittances is further added to the projection display apparatus 100.

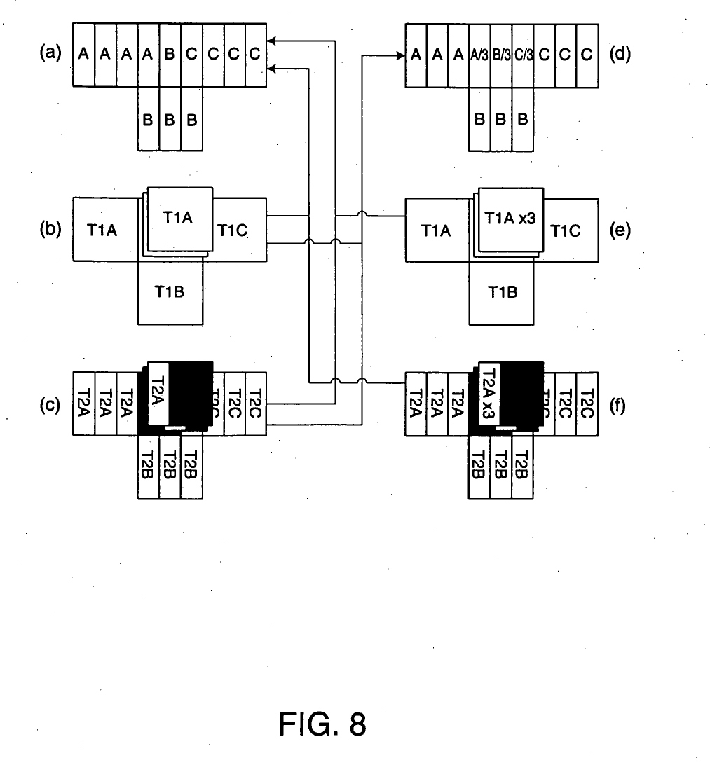

As below, according to FIG. 8, the processing of omitting the switching processing of transmittances when all of the display contents are the same for the plural pixels of the brightness modulator light valve and the processing of compensating for the display brightness that is reduced by the switching processing of transmittances, will be described.

Here, FIG. 8(a) is a schematic showing the correspondence of the respective pixels of the brightness modulator light valve to the pixel values of the display image data, (b) is a schematic showing details on switching of transmittances at the color modulator light valve side in response to the display contents in (a), (c) is a schematic showing details on switching of transmittances at the brightness modulator light valve side in response to the display contents in (a), (d) is a schematic showing display results by the combination of switching processing in (b) and (c), (e) is a schematic showing an example of performing processing of compensating for brightness at the color modulator light valve side, and (f) is a schematic showing an example of performing processing of compensating for brightness at the brightness modulator light valve side. Note that FIGS. 8(a) to (f) showing the case where three pixels of the brightness modulator light valve are made to correspond to one pixel of the color modulator light valve.

As shown in FIG. 8(a), regarding twelve pixels (three pixels×4) of the brightness modulator light valve corresponding to four pixels (one pixel×4) of the color modulator light valve, when the display contents thereof are different contents (ABC) for upper middle three pixels, respectively, and the contents with respect to each block of three pixels of the other nine pixels on the upper left (AAA), upper right (CCC) and lower middle (BBB) are the same contents, time-series display processing is performed on the upper middle three pixels in the same way as in the exemplary embodiment.

On the other hand, regarding the rest nine pixels, for example, with respect to the upper left three pixels, after the transmittances of the corresponding pixels of the color modulator light valve are switched to the transmittance in response to the pixel data (common transmittance to the three pixels), the same transmittance is maintained until 1/40 seconds has elapsed. On the other hand, according to the switching timing of the color modulator light valve, the transmittances for the upper left three pixels of the brightness modulator light valve are also set to the transmittance in response to the pixel data (common transmittance to the three pixels), and this is also maintained for 1/40 seconds. This processing is performed similarly on the upper right three pixels and the lower middle three pixels. Thereby, the load on the display processing performed on the rest nine pixels can be reduced compared to the display processing performed on the upper middle three pixels by the color modulator light valve and the brightness modulator light valve.

Here, as shown in FIGS. 8(b) and (c), when the above described series of switching processing is performed using transmittances T1A to T1C in response to brightness information of the display image in the color modulator light valve, and using transmittances T2A to T2C in response to brightness information of the display image in the brightness modulator light valve, the display result shown in FIG. 8(d) is obtained. That is, as shown in FIG. 8(d), in the upper middle three pixels, the brightness of the image of the display result is one-third of that of the surrounding nine pixels. This is because that transmission time of light becomes longer compared to that in the time series display processing (switching display at 1/120 seconds) on the upper middle three pixels by the amount of omission of switching processing (the amount of maintaining display for 1/40 seconds) in the surrounding nine pixels. Thereby, in the surrounding nine pixels, the amount of light three times larger than in the upper middle three pixels is transmitted, and thus, the brightness of the display image becomes about three times higher.

In the modified exemplary example 1, as shown in FIG. 8(e), the values of the transmittances T1A to T1C can be determined so that, for one pixel of the color modulator light valve corresponding to the upper middle three pixels in FIG. 8(a), the transmittances for tripling the respective display brightness values of the three pixels may be set in a time-sharing manner based on the brightness information of the corresponding three pixel values of the HDR display data. Therefore, by performing the same switching processing as in the above described exemplary embodiment using the transmittances T1A to T1C for tripling the display brightness, the amount of light transmitted through the corresponding pixels of the color modulator light valve can be increased to about three times larger. Thereby, with respect to the upper middle three pixels, an image is displayed with about triple brightness compared to the display result in FIG. 8(d) on the screen. That is, the brightness of the display image by the upper middle three pixels becomes substantially the same as the brightness of the display image by the surrounding nine pixels with the switching processing omitted.

Further, not limited to the correction method of brightness shown in FIG. 8(e), but, as shown in FIG. 8(f), the brightness of the display image can be increased to three times higher with respect to the upper middle three pixels by setting the transmittances of the brightness modulator light valve side so as to provide triple brightness. By the way, the correction processing of display brightness shown in FIGS. 8(e) and 8(f) may be combined to increase the display brightness.

As described above, according to the projection display apparatus 100 of the modified exemplary example 1, by combining the omission of the above described switching processing and correction processing of brightness, the display image brightness can be increased in a balanced manner.

### MODIFIED EXEMPLARY EXAMPLE 2

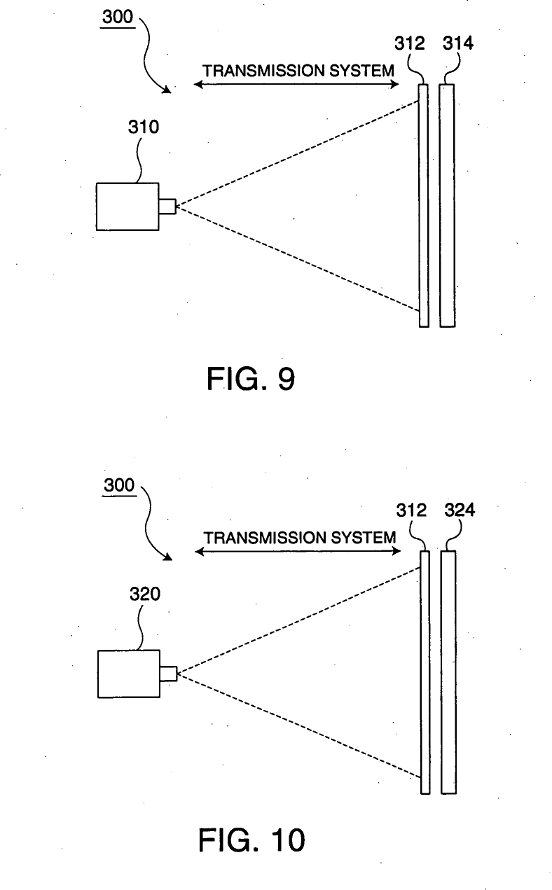

Further, in the above described exemplary embodiment, the projection display apparatus 100 has the color modulator unit 14 and the brightness modulator unit 15 built in, however, not limited to that, but, as shown in FIG. 9, removing the projector unit 16, the apparatus may be formed as a direct-view display system 300 including a 3-LCD projection display apparatus 310 for modulating brightness of light with respect to RGB three primary colors, a floodlight Fresnel lens 312 for receiving projected light from the 3-LCD projection display apparatus 310, and a direct-view brightness modulator panel 314 provided at the exit side of the Fresnel lens 312 for modulating brightness of all wavelength ranges of light.

FIG. 9 is a schematic block diagram showing a principal optical configuration of the direct-view display system 300.

Here, the 3-LCD projection display apparatus 310 is a 3-LCD high temperature polysilicon TFT liquid crystal color panel projection system, and the resolution thereof is 18 pixels wide×12 pixels high. On the other hand, the brightness modulator panel 314 is a single LCD brightness amorphous silicon TFT liquid crystal display panel with no color filter, and the resolution thereof is 54 pixels wide×12 pixels high. That is, the row direction resolution of the brightness modulator panel 314 is twice the row direction resolution of the 3-LCD projection display apparatus 310. Therefore, in the direct-view display system 300 of the modified example 2, time-series display processing of HDR images can be performed in the same way as in the exemplary embodiment.

Further, in the constitution as the direct-view display system 300, it is necessary to drive the brightness modulator panel 314 at a triple speed when the above described time-series display processing is performed. Therefore, it is necessary to select a liquid crystal display panel specified to endure the triple speed drive in consideration of liquid crystal materials, liquid crystal modes (high-speed TN, OCB), mounting methods (narrow liquid crystal layer), etc.

By the recent development of technologies in the liquid crystal display panel field, as the brightness modulator panel 314, the pixel structure of a general amorphous silicon TFT liquid crystal display panel can be used without change. That is, it can be used only by detaching a color filter from a general amorphous silicon TFT liquid crystal display panel or replacing the color filter with a monochrome filter. Therefore, a related art production line can be utilized without change and the cost becomes very advantageous. That is, high image quality can be realized at low cost.

Further, not limited to the constitution as in FIG. 9, but, as shown in FIG. 10, the apparatus may be formed as a direct-view display system 300 including a single LCD projection display apparatus 320 for modulating brightness in all wavelength ranges of light, a floodlight Fresnel lens 312 for receiving projected light from the single LCD projection display apparatus 320, and a color modulator panel 324 provided at the exit side of the Fresnel lens 312 for modulating brightness of light with respect to RGB three primary colors. In this case, similarly, the same time-series display processing can be performed.

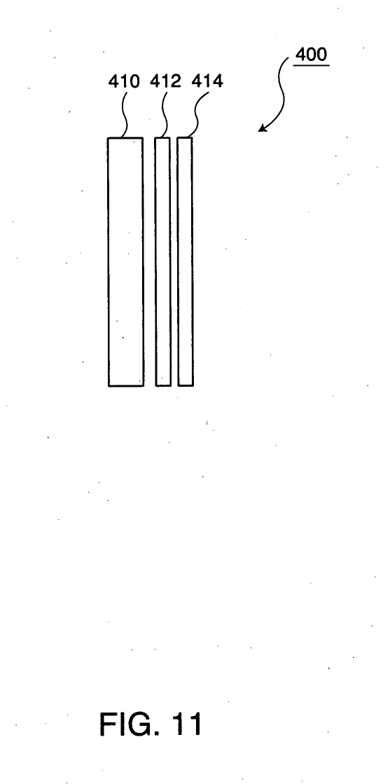

Further, in the above described exemplary embodiment, the projection display apparatus 100 has the color modulator unit 14 and the brightness modulator unit 15 built in. However, not limited to that, but, as shown in FIG. 11, removing the projector unit 16, the apparatus may be formed as a display 400 including a backlight 410, a brightness modulator panel 412 for modulating brightness in all wavelength ranges of light provided at the exit side of the backlight 410, and a color modulator panel 414 for modulating brightness of the light with respect to RGB three primary colors provided at the exit side of the brightness modulator panel 412. In this case, similarly, the same time-series display processing can be performed.

### MODIFIED EXEMPLARY EXAMPLE 3

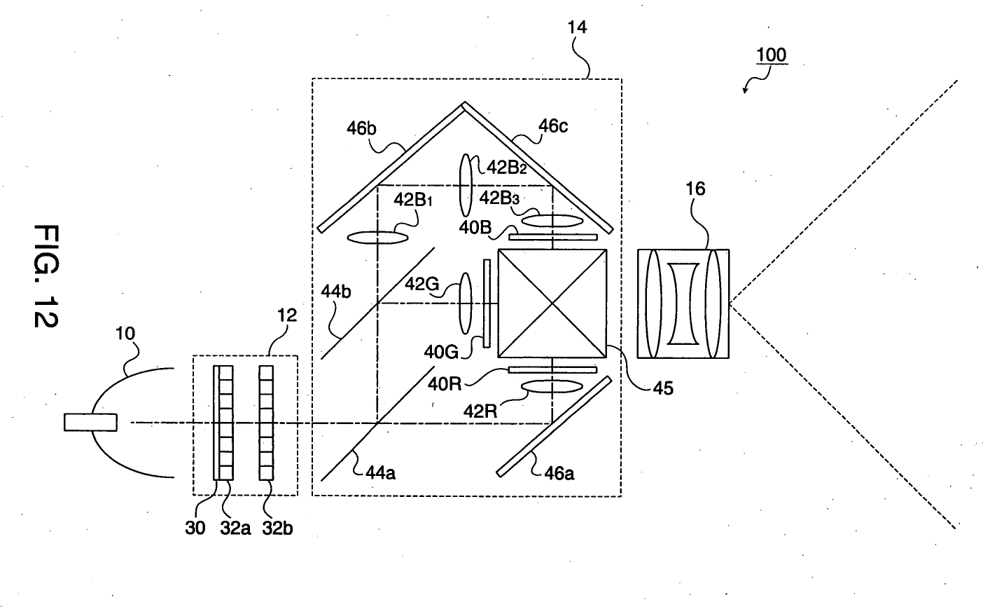

In the above described exemplary embodiment, the projection display apparatus 100 has the brightness modulator light valve disposed in the subsequent stage to the color modulator light valves. However, not limited to that, as shown in FIG. 12, the apparatus may have a constitution in which the brightness modulator light valve is disposed in the precedent stage of the color modulator light valves.

Here, FIG. 12 is a schematic showing the principal optical configuration when the brightness modulator light valve is disposed in the precedent stage of the color modulator light valves in the projection display apparatus 100.

As shown in FIG. 12, the projection display apparatus 100 in the modified exemplary example 3 includes a light source 10, a brightness modulator unit 12 for modulating brightness in all wavelength ranges of light entering from the light source 10, a color modulator unit 14 for respectively modulating brightness of RGB three primary colors of wavelength ranges of light entering from the brightness modulator unit 12, and a projector unit 16 for projecting the light entering from the color modulator unit 14 onto a screen (not shown).

The brightness modulator unit 12 includes a liquid crystal light valve 30 in which plural pixels with independently controllable transmittances arranged in a matrix form and two fly-eye lenses 32a and 32b. Further, the brightness in all wavelength ranges of light from the light source 10 is modulated by the liquid crystal light valve 30, and the modulated light is output to the color modulator unit 14 via the fly-eye lenses 32a and 32b.

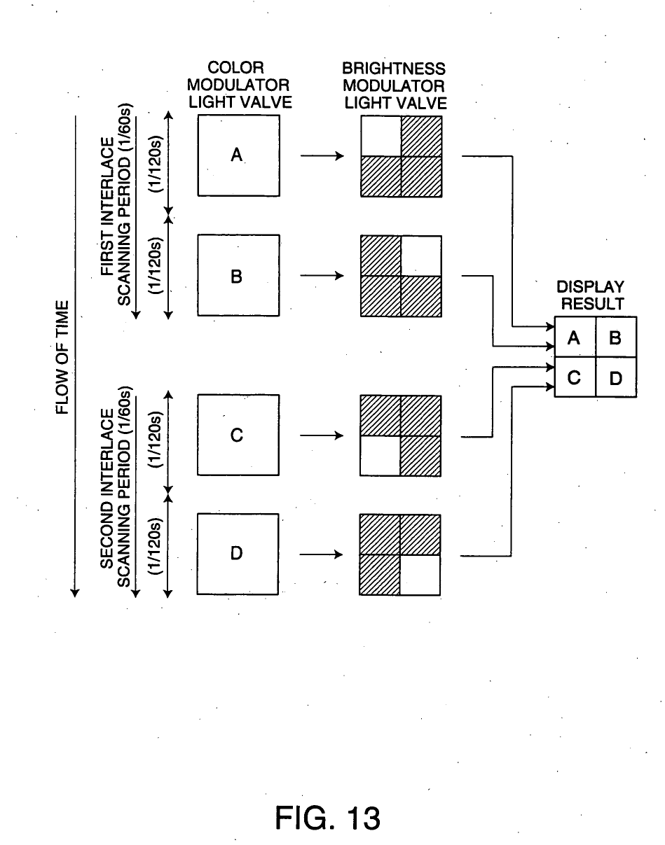

In the modified exemplary example 3, the pixel surface of the color modulator light valve (liquid crystal light valves 40R to 40B) is formed by 960 pixels wide×540 pixels high and the pixel surface of the brightness modulator light valve (liquid crystal light valve 30) is formed by 1920 pixels wide×1080 pixels high. That is, the lateral and longitudinal resolution of the brightness modulator light valve is just twice the lateral and longitudinal resolution of the color modulator light valve. In the projection display apparatus 100 having the constitution shown in FIG. 12, the same processing as in the above described exemplary embodiment can be performed. However, in the modified exemplary example 3, each pixel of the color modulator light valve is made to optically correspond to the adjacent four pixels (two pixels wide×two pixels high) of the brightness modulator light valve, and display processing in combination of the time-series display processing in the exemplary embodiment and a related art interlace scanning is performed on the four pixels of the brightness modulator light valve corresponding to each pixel of the color modulator light valve. As below, the display processing of HDR images in the modified exemplary example 3 will be described according to FIG. 13. FIG. 13 is a schematic showing a flow of the display processing of HDR images in the modified exemplary example 3.

As shown in FIG. 13, pixels A to D of the brightness modulator light valve correspond to one pixel of the color modulator light valve (here, for convenience of explanation, a pixel X will be described as a representative thereof). Therefore, in the modified exemplary example 3, with respect to corresponding four pixel data a to d of the HDR display data, it is necessary to determine transmittances T1A(R) to T1A(B), T1B(R) to T1B(B), T1C(R) to T1C(B), and T1D(R) to T1D(B) for the pixel X of the color modulator light valve. The determination of transmittances is determined based on the above described equations (1) and (2) in the same way as in the above described exemplary embodiment. For the pixels A to D of the brightness modulator light valve, combinations of transmittances set for the pixels A to D are determined with respect to each transmittance for pixels a to d. In this case, when one of four pixels is in a transmitting condition, other three pixels are set in a non-transmitting condition (no voltage is applied). Therefore, there are four combinations of a combination in which the pixel A is set to have a transmittance T2A in response to the pixel a and the pixels B to D are set in the non-transmitting condition (referred to as T2AS), a combination in which the pixel B is set to have a transmittance T2B in response to the pixel b and the pixels A, C, and D are set in the non-transmitting condition (referred to as T2BS), a combination in which the pixel C is set to have a transmittance T2C in response to the pixel c and the pixels A, B, and D are set in the non-transmitting condition (referred to as T2CS), and a combination in which the pixel D is set to have a transmittance T2D in response to the pixel d and the pixels A to C are set in the non-transmitting condition (referred to as T2DS).

When the combinations of the transmittance of each pixel of the color modulator light valve and the transmittances of corresponding four pixels of the brightness modulator light valve are determined, control values in response to these transmittances are read out from the storage unit 182 and input to the light valve control unit 180. As below, setting processing of transmittances performed on the pixel X and the pixels A to D will be described.

The light valve control unit 180 applies drive voltages V1A(R) to V1A(B) so that the transmittances of the respective pixels X of the color modulator light valve may be T1A(R) to T1A(B) in response to the input control value as shown in FIG. 13. On the other hand, application voltages in response to the T2AS are applied to the corresponding pixels A to D of the brightness modulator light valve according to the application timing of V1A(R) to V1A(B). Thereby, the transmittances of the respective pixels X of the color modulator light valve are set to T1A(R) to T1A(B), and the transmittance of the pixel A of the brightness modulator light valve is set to T2A and the pixels C to D are set into non-transmitting condition (the lowest transmittance). Furthermore, after 1/120 seconds from this settings, similarly, the transmittance of the respective pixels X of the color modulator light valve are set to T1B(R) to T1B(B), and the transmittance of the pixel B of the brightness modulator light valve is set to T2B and the pixels A, C, and D are set into non-transmitting condition (the lowest transmittance) based on the above T2BS, after 1/120 seconds from this settings, the transmittance of the respective pixels X of the color modulator light valve are set to T1C(R) to T1C(B), and the transmittance of the pixel C of the brightness modulator light valve is set to T2C and the pixels A, B, and D are set into non-transmitting condition (the lowest transmittance) based on the above T2CS, and, after 1/120 seconds from this settings, the transmittance of the respective pixels X of the color modulator light valve are set to T1D(R) to T1D(B), and the transmittance of the pixel D of the brightness modulator light valve is set to T2D and the pixels A to C are set into the non-transmitting (the lowest transmittance) condition based on the above T2DS.

By performing the above described switching processing on all pixels of the brightness modulator light valve, at the first 1/60 seconds, as the first interlace period, from the pixels in one of even rows or odd rows of the brightness modulator light valve, transmittances in response to pixel data are set, and all of the pixels in the other rows are set into the non-transmitting (the lowest transmittance) condition. In the first interlace period, transmittances in response to the pixel data for two of the four pixels are set in unit of 1/120 seconds. Then, after the first interlace period has elapsed, the process moves to the second interlace period ( 1/60 seconds), and with respect to pixels of the other rows, transmittances in response to the pixel data for two of the four pixels are set in unit of 1/120 seconds. In the second interlace period, all of the pixels in the one rows are set into the non-transmitting (the lowest transmittance) condition.

That is, with respect to each pixel X in the color modulator light valve, in the first interlace period, T1A(R) to T1A(B) are set at the first 1/120 seconds, and T1B(R) to T1B(B) are set at the subsequent 1/120 seconds. With respect to the pixels A and B of the brightness modulator light valve, the transmittance T2A is set for the pixel A (pixels C to D are in the non-transmitting condition) at the first 1/120 seconds, and the transmittance T2B is set for the pixel B (pixels A, C, and D are in the non-transmitting condition) at the subsequent 1/120 seconds. Thereby, in the first interlace period, according to the above described human visual properties, an image formed by the lights transmitted through the upper pixels A and B are displayed.

On the other hand, in the second interlace period, T1C(R) to T1C(B) are set at the first 1/120 seconds, and T1D(R) to T1D(B) are set at the subsequent 1/120 seconds. With respect to the pixels C and D of the brightness modulator light valve, the transmittance T2C is set for the pixel C (pixels A, B, and D are in the non-transmitting condition) at the first 1/120 seconds, and the transmittance T2D is set for the pixel D (pixels A to C are in the non-transmitting condition) at the subsequent 1/120 seconds. Thereby, in the second interlace period, according to the above described human visual properties, an image formed by the lights transmitted through the lower pixels C and D are displayed.

Since the image display of the respective lines in the first interlace period and the second interlace period is performed at intervals as short as 1/60 seconds, conclusively, the human eye perceives the image formed by the lights transmitted through the pixels A to D as shown in FIG. 13.

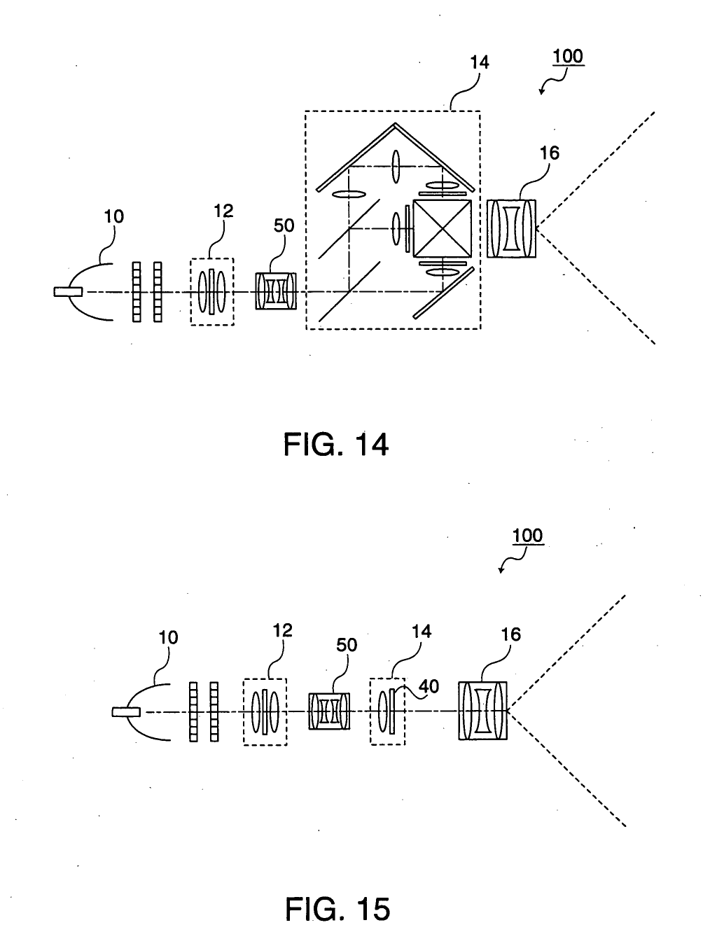

Further, in the modified exemplary example 3, the projection display apparatus 100 is formed by optically and directly connecting the brightness modulator unit 12 and the color modulator unit 14, however, not limited to that, as shown in FIG. 14, it may be formed by providing the relay lens 50 between the brightness modulator unit 12 and the color modulator unit 14.

Further, in the modified exemplary example 3, the projection display apparatus 100 is formed in the manner that the color modulator unit 14 is of a 3-LCD apparatus (the system for performing color modulation by the three liquid crystal light valves 40R to 40B). However, not limited to that, as shown in FIG. 15, the color modulator unit 14 may be formed by a single LCD apparatus (the system for performing color modulation by one liquid crystal light valves 40). The single LCD color modulator light valve can be formed by providing a color filter to a liquid crystal light valve. In this case, it is preferred to provide the relay lens 50 between the brightness modulator unit 12 and the color modulator unit 14 for enhancement in imaging accuracy.

In the projection display apparatus 100 having the constitution shown in FIG. 14 or 15, regarding the relationship between resolution of the color modulator light valve and the brightness modulator light valve, when the brightness modulator light valve has resolution an even number times that of the color modulator light valve with respect to the rows and columns, both the time-series display processing in the exemplary embodiment and the time-series display processing in the modified exemplary example 3 can be applied. On the other hand, regarding the relationship between resolution of the color modulator light valve and the brightness modulator light valve, when the brightness modulator light valve has resolution an integral number times that of the color modulator light valve in the rows or columns, the time-series display processing in the exemplary embodiment can be applied.

Further, in the direct-view display system 300 in FIG. 9 and FIG. 10 and the display 400 in FIG. 11, similarly, regarding the relationship between resolution of the color modulator light valve and the brightness modulator light valve, when the brightness modulator light valve has resolution an even number times that of the color modulator light valve with respect to the rows and columns, both the time-series display processing in the exemplary embodiment and the time-series display processing in the modified exemplary example 3 can be applied. On the other hand, regarding the relationship between resolution of the color modulator light valve and the brightness modulator light valve, when the brightness modulator light valve has resolution an integral number times that of the color modulator light valve in the rows or columns, the time-series display processing in the exemplary embodiment can be applied.

As described above, by the projection display apparatus 100 according to the modified example 3, the following effects are exerted. First, considering the case where no interlace display is performed, since four pixels of the brightness modulator light valve corresponds to one pixel of the color modulator light valve, if the time-series display processing in the above described exemplary embodiment is performed, both the color modulator light valve and the brightness modulator light valve must be quad-speed driven. Considering the response speed of liquid crystal, quad-speed display processing is difficult to be realized. On the other hand, as in the modified exemplary example 3, by performing interlace display, both the color modulator light valve and the brightness modulator light valve may be double speed driven at most, and the display processing can be realized even using a liquid crystal display panel. Further, it is said that a liquid crystal display panel as a hold-type display device is inferior in moving image display performance, however, the holding ability is relaxed by the interlace display and the moving image display performance can be enhanced. Further, the panel is compatible with interlace video signals such as 1080i. Further, since HDR image display with the resolution of the brightness modulator light valve can be performed by the color modulator light valve having half resolution of that of the brightness modulator light valve, the cost can also be reduced.

In the exemplary embodiment, the brightness modulator light valve (liquid crystal light valve 30) corresponds to the second light modulator device in any one of exemplary embodiments 1 to 11, 14 to 16, 18 to 23, 26 to 28, and 30 to 36.

Further, in the exemplary embodiment, the color modulator light valve (liquid crystal light valves 40R to 40B) corresponds to the first light modulator device in any one of exemplary embodiments 1 to 10, 14 to 16, 18 to 23, 26 to 28, and 30 to 35.

Further, in the exemplary embodiment, the time-sharing switching processing of transmittances of pixels of the color modulator light valve (liquid crystal light valves 40R to 40B) by the display control device 200 corresponds to first light propagation characteristic control device in any one of exemplary embodiments 2 to 5 and 15 to 18.

Further, in the exemplary embodiment, the time-sharing switching processing of transmittances of pixels of the brightness modulator light valve (liquid crystal light valves 40R to 40B) by the display control device 200 corresponds to second light propagation characteristic control device in any one of exemplary embodiments 2 to 6, 9, 10, 15 to 17, 19, 22, and 23.

Further, in the exemplary embodiment, step S116 corresponds to first light propagation characteristic control device in any one of exemplary embodiments 2 to 5 and 15 to 18 or the first light propagation characteristic control in any one of exemplary embodiments 27 to 30.

Further, in the exemplary embodiment, step S116 corresponds to second light propagation characteristic control device in any one of exemplary embodiments 2 to 6, 9, 10, 15 to 17, 19, 22, and 23 or a second light propagation characteristic control in any one of exemplary embodiments 27 to 29, 31, 34, and 35.

Further, in the exemplary embodiment, the liquid crystal light valves 30, 40B, 40G, and 40R are formed using active matrix liquid crystal display devices, however, not limited to that, the liquid crystal light valves 30, 40B, 40G, and 40R may be formed using passive matrix liquid crystal display devices and segment liquid crystal display devices. The active matrix liquid crystal display has an advantage that it can perform accurate gradation display, and the passive matrix liquid crystal display device and the segment liquid crystal display device have an advantage that they can be manufactured at low cost.

Further, in the exemplary embodiment, the projection display apparatus 100 is formed by providing a transmissive light modulator device, however, not limited to that, the brightness modulator light valve or the color modulator light valve can be formed by a reflective light modulator device such as an DMD (Digital Micromirror Device).

Further, in the exemplary embodiment, in the projection display apparatus 100, each pixel of the color modulator light valve is made to optically correspond to plural pixels of one brightness modulator light valve. However, not limited to that, one pixel or plural pixels of plural brightness modulator light valves may be made to optically correspond to each pixel of the color modulator light valve, and the above described time-series display processing may be performed.

Further, in the exemplary embodiment, a transmissive liquid crystal device is used as the brightness modulator light valve. However, not limited to that, a light source type modulator device (e.g., an LED, an OLED, a laser, or the like) in which the brightness itself can be modulated may be used.

Further, in the exemplary embodiment, in the execution of the processing shown in the flowchart in FIG. 7, the case of executing the control program that has been stored in advance in the ROM 172 has been described. However, not limited to that, from a storage medium in which a program expressing the procedure is stored, the program may be read in the RAM 174 and executed.

Here, the storage medium is a semiconductor storage medium such as a RAM and ROM, a magnetic storage type storage medium such as an FD and HD, an optical reading storage medium such as a CD, a CDV, an LD, a DVD, and a magnetic storage type/optical reading storage medium such as an MO, and includes any computer-readable storage media regardless of reading methods such as electronic, magnetic, optical methods or the like.

1. A light modulating apparatus applied to an optical system, comprising:
a first light modulator device having a plurality of pixels with independently controllable light propagation characteristics; and
a second light modulator device having a larger number of pixels than the first light modulator device with independently controllable light propagation characteristics to make the pixels of the first light modulator device optically correspond to the pixels of the second light modulator device at a ratio 1:n, where n is an integral number equal to or more than 2, and to modulate light from a light source via the first light modulator device and the second light modulator device,
the first and second modulators setting a plurality of kinds of control patterns in which part of n pixels of the second light modulator device are made to have predetermined light propagation characteristics and the rest are made to have light propagation characteristics to provide at least one of the lowest and substantially the lowest light propagation efficiency, and
the first and second modulators controlling n pixels of the second light modulator device corresponding to one pixel of the first light modulator device with one of the plurality of kinds of control patterns' and switching the control pattern of the pixels of the second light modulator device according to switching timing of the light propagation characteristics of the pixel of the first light modulator device.

2. An optical display apparatus, comprising:
a first light modulator device having a plurality of pixels with independently controllable light propagation characteristics; and
a second light modulator device having a plurality of pixels with independently controllable light propagation characteristics to make the pixels of the first light modulator device optically correspond to the pixels of the second light modulator device at a ratio of 1:n, where n is an integral number equal to or more than 2, and to display an image by modulating light from a light source via the first light modulator device and the second light modulator device,
the first and second modulators segmenting a pixel value corresponding to one pixel of display image data into a pixel value to control the first light modulator device and a pixel value to control the second light modulator device, respectively, and further segmenting the pixel value to control the first light modulator device into a plurality of primitive pixel values,
the first and second modulators setting a plurality of kinds of control patterns in which part of n pixels of the second light modulator device are made to have predetermined light propagation characteristics and the rest are made to have light propagation characteristics to provide at least one of the lowest and substantially the lowest light propagation efficiency based on the pixel value to control the second light modulator device,
the apparatus further includes a first light propagation characteristic control device to switch control of the light propagation characteristics of the pixel of the first light modulator device in a time-sharing manner based on the respective primitive pixel values to control the first light modulator device; and
a second light propagation characteristic control device to switch control to the control pattern of the pixels of the second light modulator device according to switching timing of the light propagation characteristics of the pixel of the first light modulator device.

3. The optical display apparatus according to claim 2, when all of the pixel values for n pixels of the second light modulator device corresponding to one pixel of the first light modulator device are the same,
the first light propagation characteristic control device switches light propagation characteristics of each pixel of the first light modulator device to light propagation characteristics based on the plurality of primitive pixel values obtained by further segmenting the pixel value and maintains the switched light propagation characteristics of interest in time according to the control of the n pixels, and
the second light propagation characteristic control device switch controls light propagation characteristics of the n pixels to light propagation characteristics based on the pixel value according to switching timing of each pixel of the first light modulator device.

4. The optical display apparatus according to claim 2, the first light propagation characteristic control device and the second light propagation characteristic control device performing the switch control when an image to be displayed is a still image.

5. The optical display apparatus according to claim 2, the first light propagation characteristic control device switches light propagation characteristics in response to the primitive pixel values in each pixel of the first light modulator device to characteristics with propagation efficiency higher than light propagation efficiency of pixels of the second light modulator device corresponding to each pixel of interest based on the display image data.

6. The optical display apparatus according to claim 2, the second light propagation characteristic control device switches light propagation characteristics in response to the pixel values for controlling the second light modulator device of the pixels in the second light modulator device to characteristics with propagation efficiency higher than light propagation efficiency of the pixel of the first light modulator device corresponding to the pixels of interest based on the display image data.

7. The optical display apparatus according to claim 2, both the first light modulator device and the second light modulator device having the pixels arranged in a matrix form, and the number of pixels of the second light modulator device being an integral number times the number of pixels of the first light modulator device both in row and column directions, and, with respect to each pixel of the first light modulator device, the pixel of interest regularly and optically corresponds to n pixels of the second light modulator device.

8. The optical display apparatus according to claim 7, further comprising:
a plurality of the first light modulator devices corresponding to lights in a plurality of different wavelength ranges,
with respect to each pixel of each of the first light modulator device, the pixel of interest regularly and optically corresponding to n pixels of the second light modulator device.

9. The optical display apparatus according to claim 7, the number of pixels in the column direction of the second light modulator device being twice the number of pixels in the row direction of the first light modulator device, and
the second light propagation characteristic control device performing the switch control processing of light propagation characteristics in response to the pixel values of the display image data in order from one of even rows or odd rows of the second light modulator device and, during performance of the switch control of interest, switches the light propagation characteristics of pixels in the other rows to characteristics for providing at least one of the lowest and substantially the lowest light propagation efficiency.

10. The optical display apparatus according to claim 7, the number of pixels in the row direction of the second light modulator device being twice the number of pixels in the column direction of the first light modulator device, and
the second light propagation characteristic control device performing the switch control processing of light propagation characteristics in response to the pixel values of the display image data in order from one of even columns or odd columns of the second light modulator device and, during performance of the switch control of interest, switches the light propagation characteristics of pixels in the other columns to characteristics for providing at least one of the lowest and substantially the lowest light propagation efficiency.

11. The optical display apparatus according to claim 2, the second light modulator device being a liquid crystal display device.

12. A light modulating apparatus applied to an optical system, comprising:
a light modulator device having a plurality of pixels with independently controllable light propagation characteristics; and
a brightness adjuster light source having a plurality of light sources with independently adjustable brightness to make the pixels of the light modulator device optically correspond to the light sources of the brightness adjuster light source at a ratio of 1:n, where n is an integral number equal to or more than 2, and to modulate light from the brightness adjuster light source via the light modulator device,
the apparatus setting a plurality of kinds of control patterns in which part of n light sources of the brightness adjuster light source are turned on at predetermined brightness and the rest are not turned on, and
controlling n light sources of the brightness adjuster light source corresponding to one pixel of the light modulator device with one of the plurality of kinds of control patterns and switching the control pattern of n light sources of the brightness adjuster light source corresponding to each of the pixels according to switching timing of the light propagation characteristics of each pixel of the light modulator device.

13. A light modulating apparatus applied to an optical system, comprising:
a brightness adjuster light source having a plurality of light sources with independently adjustable brightness; and
a light modulator device having a plurality of pixels with independently controllable light propagation characteristics to make the light sources of the brightness adjuster light source optically correspond to the pixels of the light modulator device at a ratio of 1:n, where n is an integral number equal to or more than 2, and to modulate light from the brightness adjuster light source via the light modulator device,
the apparatus setting a plurality of kinds of control patterns in which part of n pixels of the light modulator device are made to have predetermined light propagation characteristics and the rest are made to have light propagation characteristics to provide at least one of the lowest and substantially the lowest light propagation efficiency, and
controlling n pixels of the light modulator device corresponding to one light source of the brightness adjuster light source with one of the plurality of kinds of control patterns and switching the control pattern of n pixels of the light modulator device corresponding to each of the light sources according to switching timing of brightness of each light source of the brightness adjuster light source.

14. A light modulation control program for use with a light modulating apparatus applied to an optical system, the modulator including a first light modulator device having a plurality of pixels with independently controllable light propagation characteristics and a second light modulator device having a larger number of pixels than the first light modulator device with independently controllable light propagation characteristics to make the pixels of the first light modulator device optically correspond to the pixels of the second light modulator device at a ratio of 1:n, where n is an integral number equal to or more than 2, and to modulate light from a light source via the first light modulator device and the second light modulator device, the program, for use with a computer, comprising:
a program for setting a plurality of kinds of control patterns in which part of n pixels of the second light modulator device are made to have predetermined light propagation characteristics and the rest are made to have light propagation characteristics to provide at least one of the lowest and substantially the lowest light propagation efficiency; and
a program for controlling n pixels of the second light modulator device corresponding to one pixel of the first light modulator device with one of the plurality of kinds of control patterns and switching the control pattern of the pixels of the second light modulator device according to switching timing of the light propagation characteristics of the pixel of the first light modulator device.

15. An optical display apparatus control program for use with a light modulating apparatus and to control an optical display apparatus, the modulator including a first light modulator device having a plurality of pixels with independently controllable light propagation characteristics and a second light modulator device having a plurality of pixels with independently controllable light propagation characteristics to make the pixels of the first light modulator device optically correspond to the pixels of the second light modulator device at a ratio of 1:n, where n is an integral number equal to or more than 2, and to display an image by modulating light from the light source via the first light modulator device and the second light modulator device, the program for use with a computer, comprising:
a program for segmenting a pixel value corresponding to one pixel of display image data into a pixel value to control the first light modulator device and a pixel value for controlling the second light modulator device, respectively, and further for segmenting the pixel value to control the first light modulator device into a plurality of primitive pixel values,
a program for setting a plurality of kinds of control patterns in which part of n pixels of the second light modulator device are made to have predetermined light propagation characteristics and the rest are made to have light propagation characteristics to provide at least one of the lowest and substantially the lowest light propagation efficiency based on the pixel value to control the second light modulator device; and
a program for switch controlling the light propagation characteristics of the pixel of the first light modulator device in a time-sharing manner based on the respective primitive pixel values to control the first light modulator device; and
a program for switch controlling the control pattern of the pixels of the second light modulator device according to switching timing of the light propagation characteristics of the pixel of the first light modulator device.

16. A light modulation control program for use with a light modulating apparatus and applied to an optical system, the modulator including a light modulator device having a plurality of pixels with independently controllable light propagation characteristics and a brightness adjuster light source having a plurality of light sources with independently adjustable brightness to make the pixels of the light modulator device optically correspond to the light sources of the brightness adjuster light source at a ratio of 1:n, where n is an integral number equal to or more than 2, to modulate light from the brightness adjuster light source via the light modulator device, the program for use with a computer comprising:
a program for setting a plurality of kinds of control patterns in which part of n light sources of the brightness adjuster light source are turned on at predetermined brightness and the rest are not turned on, and
a program for controlling n light sources of the brightness adjuster light source corresponding to one pixel of the light modulator device with one of the plurality of kinds of control patterns and switching the control pattern of n light sources of the brightness adjuster light source corresponding to each of the pixels according to switching timing of the light propagation characteristics of each pixel of the light modulator device.

17. A light modulation control program for use with a light modulating apparatus and applied to an optical system, the modulator including a brightness adjuster light source having a plurality of light sources with independently adjustable brightness and a light modulator device having a plurality of pixels with independently controllable light propagation characteristics to make the light sources of the brightness adjuster light source optically correspond to the pixels of the light modulator device at a ratio of 1:n, where n is an integral number equal to or more than 2, and to modulate light from the brightness adjuster light source via the light modulator device, the program for use with a computer comprising:
a program for setting a plurality of kinds of control patterns in which part of n pixels of the light modulator device are made to have predetermined light propagation characteristics and the rest are made to have light propagation characteristics to provide the lowest or substantially the lowest light propagation efficiency, and
a program for controlling n pixels of the light modulator device corresponding to one light source of the brightness adjuster light source with one of the plurality of kinds of control patterns and switching the control pattern of n pixels of the light modulator device corresponding to each of the light sources according to switching timing of brightness of each light source of the brightness adjuster light source.

18. A light modulation control method applied to an optical system, including a first light modulator device having a plurality of pixels with independently controllable light propagation characteristics and a second light modulator device having a larger number of pixels than the first light modulator device with independently controllable light propagation characteristics for making the pixels of the first light modulator device optically correspond to the pixels of the second light modulator device at a ratio of 1:n, where n is an integral number equal to or more than 2, and modulating light from a light source via the first light modulator device and the second light modulator device, the method comprising:
setting a plurality of kinds of control patterns in which part of n pixels of the second light modulator device are made to have a predetermined light propagation characteristic and the rest are made to have light propagation characteristics for providing the lowest or substantially the lowest light propagation efficiency, and
controlling n pixels of the second light modulator device corresponding to one pixel of the first light modulator device with one of the plurality of kinds of control patterns and switching the control pattern of the pixels of the second light modulator device according to switching timing of the light propagation characteristics of the pixel of the first light modulator device.

19. An optical display apparatus control method for controlling an optical display apparatus, including a first light modulator device having a plurality of pixels with independently controllable light propagation characteristics and a second light modulator device having a plurality of pixels with independently controllable light propagation characteristics for making the pixels of the first light modulator device optically correspond to the pixels of the second light modulator device at a ratio of 1:n, where n is an integral number equal to or more than 2, and displaying an image by modulating light from the light source via the first light modulator device and the second light modulator device, the method comprising:
segmenting a pixel value corresponding to one pixel of display image data into a pixel value for controlling the first light modulator device and a pixel value for controlling the second light modulator device, respectively, and further segmenting the pixel value for controlling the first light modulator device into a plurality of primitive pixel values,
setting a plurality of kinds of control patterns in which part of n pixels of the second light modulator device are made to have predetermined light propagation characteristics and the rest are made to have light propagation characteristics for providing at least one of the lowest and substantially the lowest light propagation efficiency based on the pixel value for controlling the second light modulator device, and
switch controlling the light propagation characteristics of the pixel of the first light modulator device in a time-sharing manner based on the respective primitive pixel values for controlling the first light modulator device; and
switch controlling the control pattern of the pixels of the second light modulator device according to switching timing of the light propagation characteristics of the pixel of the first light modulator device.

20. A light modulation control method applied to an optical system, including a light modulator device having a plurality of pixels with independently controllable light propagation characteristics and a brightness adjuster light source having a plurality of light sources with independently adjustable brightness for making the pixels of the light modulator device optically correspond to the light sources of the brightness adjuster light source at a ratio of 1:n, where n is an integral number equal to or more than 2, and modulating light from the brightness adjuster light source via the light modulator device, the method comprising:
setting a plurality of kinds of control patterns in which part of n light sources of the brightness adjuster light source are turned on at predetermined brightness and the rest are not turned on, and
controlling n light sources of the brightness adjuster light source corresponding to one pixel of the light modulator device with one of the plurality of kinds of control patterns and switching the control pattern of n light sources of the brightness adjuster light source corresponding to each of the pixels according to switching timing of the light propagation characteristics of each pixel of the light modulator device.

21. A light modulation control method applied to an optical system, including a brightness adjuster light source having a plurality of light sources with independently adjustable brightness and a light modulator device having a plurality of pixels with independently controllable light propagation characteristics for making the light sources of the brightness adjuster light source optically correspond to the pixels of the light modulator device at a ratio of 1:n, where n is an integral number equal to or more than 2, and modulating light from the brightness adjuster light source via the light modulator device, the method comprising:
setting a plurality of kinds of control patterns in which part of n pixels of the light modulator device are made to have predetermined light propagation characteristics and the rest are made to have light propagation characteristics for providing at least one of the lowest and substantially the lowest light propagation efficiency, and
controlling n pixels of the light modulator device corresponding to one light source of the brightness adjuster light source with one of the plurality of kinds of control patterns and switching the control pattern of n pixels of the light modulator device corresponding to each of the light sources according to switching timing of brightness of each light source of the brightness adjuster light source.
